(19) United States
(12) Patent Application Publication
(10) Pub. No.: US 2026/0045207 A1
(43) Pub. Date: Feb. 12, 2026

(54) DISPLAY DEVICE AND ELECTRONIC DEVICE INCLUDING THE SAME

(71) Applicant: Samsung Display Co., Ltd., Yongin-Si (KR)

(72) Inventors: WOO-CHUL KIM, Yongin-si (KR); JAEHYUN KOH, Yongin-si (KR); DOWON KIM, Yongin-si (KR); MIN-WEUN KIM, Yongin-si (KR); WOONYONG LIM, Yongin-si (KR)

(21) Appl. No.: 19/250,066

(22) Filed: Jun. 26, 2025

(30) Foreign Application Priority Data
Aug. 9, 2024 (KR) 10-2024-0106801

(51) Int. Cl. G09G 3/32

(52) U.S. Cl. CPC G09G 3/32; G09G 2300/0819; G09G 2310/0275; G09G 2320/0233; G09G 2320/0242; G09G 2320/0257; G09G 2320/0271; G09G 2330/021; G09G 2330/028

(57) ABSTRACT

A display device may include a display panel including a pixel, a data driver configured to apply a data voltage based on a data signal to the pixel, a voltage generator configured to generate driving voltages based on a voltage generation control signal and a driving controller configured to generate the data signal and control the data driver and the voltage generator. The pixel may emit light at a setting grayscale based on the driving voltages and the data voltage. At least one driving voltage of the driving voltages may be changed based on a setting luminance. The data signal may be generated based on a change of the at least one driving voltage and a voltage difference between a data voltage of a reference grayscale and a data voltage of the setting grayscale.

### CROSS-REFERENCE TO RELATED APPLICATION(S)

This application claims priority under 35 USC § 119 to Korean Patent Application No. 10-2024-0106801, filed on Aug. 9, 2024 in the Korean Intellectual Property Office (KIPO), the content of which is herein incorporated by reference in its entirety.

### BACKGROUND

### 1. Field

Embodiments of the present inventive concept relate to a display device and an electronic device including the same. More particularly, embodiments of the present inventive concept relate to a display device improving the display quality.

### 2. Description of the Related Art

Generally, a display device includes a display panel and a display panel driver. The display panel includes a plurality of gate lines, a plurality of data lines, a plurality of emission lines and a plurality of pixels. The display panel driver includes a gate driver providing a gate signal to the gate lines, a data driver providing a data voltage to the data lines, an emission driver providing an emission signal to the emission lines and a driving controller controlling the gate driver, the data driver and the emission driver.

Generally, a driving voltage of a display device may be reduced for reducing a power consumption of the display device.

### SUMMARY

Embodiments of the present inventive concept provide a display device improving a display quality by compensating an influence according to a change of a driving voltage.

Embodiments of the present inventive concept also provide an electronic device including the display device.

According to embodiments, a display device may include a display panel including a pixel, a data driver configured to apply a data voltage based on a data signal to the pixel, a voltage generator configured to generate driving voltages based on a voltage generation control signal and a driving controller configured to generate the data signal and control the data driver and the voltage generator. The pixel may emit light at a setting grayscale based on the driving voltages and the data voltage. At least one driving voltage of the driving voltages may be changed based on a setting luminance. The data signal may be generated based on a change of the at least one driving voltage and a voltage difference between a data voltage of a reference grayscale and a data voltage of the setting grayscale.

In an embodiment, the driving controller may generate the data signal based on the voltage difference, the change of the at least one driving voltage and offset data corresponding to the change of the at least one driving voltage.

In an embodiment, the offset data may be generated based on an offset look-up table corresponding to the change of the at least one driving voltage.

In an embodiment, the driving controller may store a plurality of offset look-up tables comprising the offset look-up table. The offset look-up tables may include a first offset look-up table, a second offset look-up table and a third offset look-up table. The third offset look-up table may be generated through linear interpolation with the first offset look-up table and the second offset look-up table.

In an embodiment, the data signal may include a first data signal for outputting a data voltage corresponding to a first grayscale and a second data signal for outputting a data voltage corresponding to a second grayscale higher than the first grayscale. The first data signal may be generated based on the voltage difference, the change of the at least one driving voltage and the offset data. The second data signal may be generated based on the voltage difference and the offset data.

In an embodiment, the data signal may be generated based on a final offset voltage. The final offset voltage may be calculated by using a first equation. The first equation is Vfoff=ΔDV*offset(Gray)*(Vdata_{REF}−Vdata_{Gray}), and the Vfoff is the final offset voltage, the ΔDV is the change of the at least one driving voltage, the offset(Gray) is a voltage corresponding to the offset data and the Vdata_{REF}−Vdata_{Gray} is the voltage difference.

In an embodiment, the driving controller may include an input control signal receiver configured to output the voltage generation control signal and change data corresponding to a change of the at least one driving voltage, an offset determiner configured to output the offset data based on the change data and a data signal compensator configured to receive the change data and the offset data, and generate the data signal considering a final offset voltage in a data voltage corresponding to input image data. The data signal compensator may calculate the final offset voltage based on the change data, the offset data and the voltage difference.

In an embodiment, the pixel may include a driving transistor configured to output a driving current based on the data voltage and a high power voltage, a write transistor configured to apply the data voltage to the driving transistor in response to a gate signal and a light emitting element including a first electrode receiving the driving current and a second electrode receiving a low power voltage. The driving voltages may include the high power voltage and the low power voltage. The at least one driving voltage may be the low power voltage.

In an embodiment, the driving controller may generate the data signal based on the voltage difference, a change of the low power voltage and low power voltage offset data corresponding to the change of the low power voltage.

In an embodiment, the pixel may include a driving transistor configured to output a driving current based on the data voltage and a high power voltage, a writing transistor configured to apply the data voltage to the driving transistor in response to a gate signal, an initialization transistor configured to apply an initialization voltage to a control electrode of the driving transistor and a light emitting element including a first electrode receiving the driving current and a second electrode receiving a low power voltage. The driving voltages may include the high power voltage, the low power voltage and the initialization voltage. The at least one driving voltage may be the initialization voltage. The driving controller may generate the data signal based on the voltage difference, a change of the initialization voltage and initialization voltage offset data corresponding to the change of the initialization voltage.

In an embodiment, the display device may further include a gate driver configured to generate a gate signal based on a gate high voltage and a gate low voltage. The pixel may include a driving transistor configured to output a driving current based on the data voltage and a high power voltage, a writing transistor configured to apply the data voltage to the driving transistor in response to a gate signal, an initialization transistor configured to apply an initialization voltage to a control electrode of the driving transistor and a light emitting element including a first electrode receiving the driving current and a second electrode receiving a low power voltage. The driving voltages may include the gate high voltage, the gate low voltage, the high power voltage, the low power voltage and the initialization voltage. The at least one driving voltage may be the gate low voltage. The driving controller may generate the data signal based on the voltage difference, a change of the gate low voltage and gate voltage offset data corresponding to the change of the gate low voltage.

In an embodiment, the display device may further include a gate driver configured to generate a gate signal based on a gate high voltage and a gate low voltage. The pixel may include a driving transistor configured to output a driving current based on the data voltage and a high power voltage, a writing transistor configured to apply the data voltage to the driving transistor in response to a gate signal, an initialization transistor configured to apply an initialization voltage to a control electrode of the driving transistor and a light emitting element including a first electrode receiving the driving current and a second electrode receiving a low power voltage. The driving voltages may include the gate high voltage, the gate low voltage, the high power voltage, the low power voltage and the initialization voltage. The at least one driving voltage may be the low power voltage, the initialization voltage and the gate low voltage. The driving controller may generate the data signal based on the voltage difference, a change of the low power voltage and integration offset data.

In an embodiment, the integration offset data may be generated based on an integration offset look-up table considering the change of the low power voltage, a change of the initialization voltage and a change of the gate low voltage.

In an embodiment, the reference grayscale may be a maximum grayscale in which the pixel emits light.

According to embodiments, a display device may include a display panel including a pixel, a data driver configured to apply a data voltage based on a data signal to the pixel, a voltage generator configured to generate driving voltages based on a voltage generation control signal and a driving controller configured to generate the data signal and control the data driver and the voltage generator. The pixel may emit light at a setting grayscale based on the driving voltages and the data voltage. At least one driving voltage of the driving voltages may be changed based on a setting luminance. The data signal may be generated based on a change of the at least one driving voltage and offset data corresponding to the change of the at least one driving voltage.

In an embodiment, the offset data may be generated based on an offset look-up table corresponding to the change of the at least one driving voltage.

In an embodiment, the driving controller may store a plurality of offset look-up tables comprising the offset look-up table. The offset look-up tables may include a first offset look-up table, a second offset look-up table and a third offset look-up table. The third offset look-up table may be generated through linear interpolation with the first offset look-up table and the second offset look-up table.

In an embodiment, when the setting luminance is lower than a reference luminance, the data signal may be generated based on the change of the at least one driving voltage and the offset data. When the setting luminance is higher than the reference luminance, the data signal may be generated based on a voltage difference between a data voltage of a reference grayscale and a data voltage of the setting grayscale, the change of the at least one driving voltage and the offset data.

In an embodiment, the display device may further include a gate driver configured to generate a gate signal based on a gate high voltage and a gate low voltage. The pixel may include a driving transistor configured to output a driving current based on the data voltage and a high power voltage, a writing transistor configured to apply the data voltage to the driving transistor in response to a gate signal, an initialization transistor configured to apply an initialization voltage to a control electrode of the driving transistor and a light emitting element including a first electrode receiving the driving current and a second electrode receiving a low power voltage. The driving voltages may include the gate high voltage, the gate low voltage, the high power voltage, the low power voltage and the initialization voltage. The at least one driving voltage may be the low power voltage, the initialization voltage and the gate low voltage. When the setting luminance is lower than a reference luminance, the driving controller may the data signal based on the voltage difference, a change of the low power voltage and integration offset data.

In an embodiment, the integration offset data may be generated based on an integration offset look-up table considering the change of the low power voltage, a change of the initialization voltage and a change of the gate low voltage.

In an embodiment, the pixel may include a driving transistor configured to output a driving current based on the data voltage and a high power voltage, a writing transistor configured to apply the data voltage to the driving transistor in response to a gate signal, an initialization transistor configured to apply an initialization voltage to a control electrode of the driving transistor and a light emitting element including a first electrode receiving the driving current and a second electrode receiving a low power voltage. The driving voltages may include the high power voltage, the low power voltage and the initialization voltage. The at least one driving voltage may be the initialization voltage.

According to embodiments, an electronic device may include a display panel including a pixel, a panel driver configured to drive the display panel, a power manager configured to output driving voltages to the display panel and the panel driver based on a voltage generation control signal and a controller configured to output an input control signal to the panel driver and output the voltage generation control signal. The panel driver may include a data driver configured to apply a data voltage based on a data signal to the pixel and a driving controller configured to generate the data signal and control the data driver. The pixel may emit light at a setting grayscale based on the driving voltages and the data voltage. At least one driving voltage of the driving voltages may be changed based on a setting luminance. The data signal may be generated based on a change of the at least one driving voltage and a voltage difference between a data voltage of a reference grayscale and a data voltage of the setting grayscale.

In an embodiment, the driving controller may generate the data signal based on the voltage difference, the change of the at least one driving voltage and offset data corresponding to the change of the at least one driving voltage.

In an embodiment, the offset data may be generated based on an offset look-up table corresponding to the change of the at least one driving voltage.

In an embodiment, the driving controller may store a plurality of offset look-up tables comprising the offset look-up table. The offset look-up tables may include a first offset look-up table, a second offset look-up table and a third offset look-up table. The third offset look-up table may be generated through linear interpolation with the first offset look-up table and the second offset look-up table.

In an embodiment, the data signal may be generated based on a final offset voltage. The final offset voltage may be calculated by using a first equation. The first equation is Vfoff=ΔDV*offset(Gray)*(Vdata_{REF}−Vdata_{Gray}), and the Vfoff is the final offset voltage, the ΔDV is the change of the at least one driving voltage, the offset(Gray) is a voltage corresponding to the offset data and the Vdata_{REF}−Vdata_{Gray} is the voltage difference.

As described above, some of a plurality of offset look-up tables may be generated by performing linear interpolation. Accordingly, some of the offset lookup tables may be generated without using a measuring device. Accordingly, an efficiency of the manufacturing process may be improved.

Additionally, the low power voltage may be changed according to a change of the setting luminance. For generating a data signal according to a change in the low power voltage, the low power voltage offset look-up tables may be generated. The data signal may be generated based on the low power offset look-up table corresponding to the changed low power voltage. Accordingly, the data signal considering panel characteristics may be generated. Additionally, an influence due to the change of the low power voltage according to the setting luminance may be considered. Accordingly, color distortion and/or luminance stability of the display panel may be improved.

Additionally, a final offset voltage may be considered in the data signal outputted from the driving controller. The voltage difference between the data voltage of the reference grayscale and the data voltage of the setting grayscale may be considered in the final offset voltage. The voltage difference between the data voltage of the reference grayscale and the data voltage of the setting grayscale may be considered in the final offset voltage, so that a tendency of the gamma curve may be reflected in the data voltage generated based on the data signal. Accordingly, a display quality of the display panel may be further improved.

### BRIEF DESCRIPTION OF THE DRAWINGS

Illustrative, non-limiting embodiments will be more clearly understood from the following detailed description in conjunction with the accompanying drawings.

FIG. 1 is a block diagram illustrating a display device according to embodiments of the present inventive concept.

FIG. 2 is a block diagram illustrating an example of a driving controller included in a display device.

FIG. 3 is a diagram illustrating an example of a plurality of offset look-up tables stored in a driving controller of FIG. 2.

FIG. 4 is a table illustrating an example of an offset look-up table of FIG. 3.

FIG. 5 is a diagram illustrating an example of a plurality of offset look-up tables stored in a driving controller of FIG. 2.

FIG. 6 is a table illustrating an example of an offset look-up table of FIG. 5.

FIG. 7 is a diagram illustrating an example of a plurality of offset look-up tables stored in a driving controller of FIG. 2.

FIG. 8 is a table illustrating an example of an offset look-up table of FIG. 5.

FIG. 9 is a diagram illustrating an example of a plurality of offset look-up tables stored in a driving controller of FIG. 2.

FIG. 10 is a table illustrating an example of an offset look-up table of FIG. 5.

FIG. 11 is a block diagram illustrating an example of a driving controller included in the display device of FIG. 1.

FIG. 12 is a block diagram illustrating an example of a driving controller included in the display device of FIG. 1.

FIG. 13 is a block diagram illustrating an example of a driving controller included in the display device of FIG. 1.

FIG. 14 is a circuit diagram illustrating an example of a pixel included the display device of FIG. 1.

FIG. 15 is a circuit diagram illustrating an example of pixel included in the display device of FIG. 1.

FIG. 16 is a graph illustrating a target luminance according to embodiments.

FIG. 17 is a graph illustrating a color difference according to embodiments.

FIG. 18 is a block diagram illustrating an electronic device according to an embodiment.

FIG. 19 is a block diagram illustrating an electronic device according to an embodiment.

### DETAILED DESCRIPTION OF THE INVENTIVE CONCEPT

Hereinafter, the present inventive concept will be explained in detail with reference to the accompanying drawings.

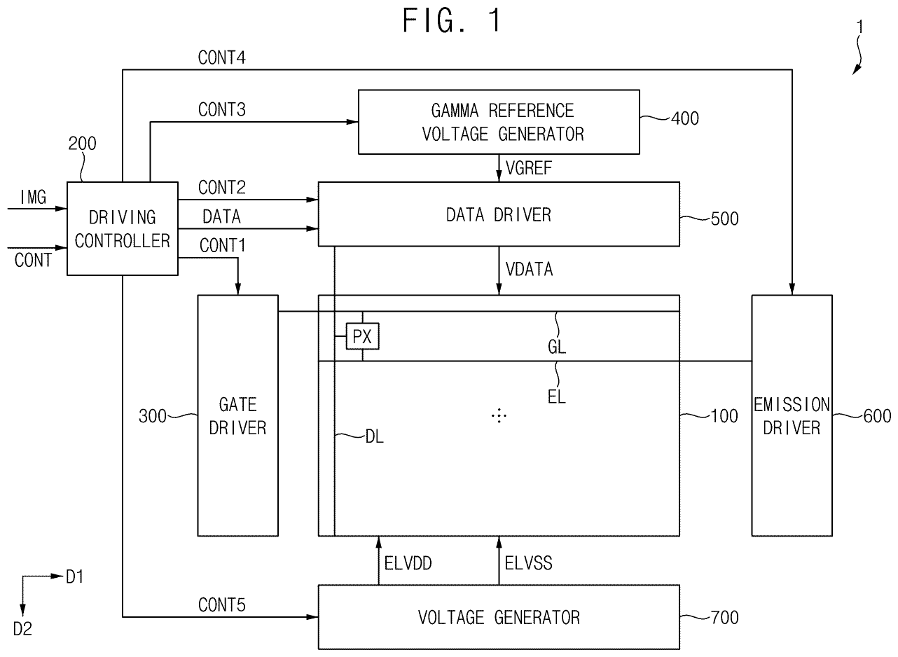

FIG. 1 is a block diagram illustrating a display device 1 according to embodiments of the present inventive concept.

Referring to FIG. 1, the display device 1 may include a display panel 100 and a panel driver. The panel driver may include a driving controller 200, a gate driver 300, a gamma reference voltage generator 400, a data driver 500 and an emission driver 600. In an embodiment, the panel driver may further include a voltage generator 700.

The display panel 100 may have a display region on which an image is displayed and a peripheral region adjacent to the display region.

The display panel 100 may include a plurality of gate lines GL, a plurality of data lines DL, a plurality of emission lines EL and a plurality of pixels PX electrically connected to the gate lines GL, the data lines DL and the emission lines EL. The gate lines GL may extend in a first direction D1. The data lines DL may extend in a second direction D2 crossing the first direction D1. The emission lines EL may extend in the first direction D1.

The display panel 100 may emit light based on a setting luminance. For example, the setting luminance may be set by user. For example, the setting luminance may mean a maximum luminance in which the display panel 100 emits. For example, the setting luminance may be the maximum luminance in which the display panel 100 emits as a grayscale corresponding to white. For example, the grayscale corresponding to the white may be about 255 grayscale level. However, the present inventive concept is not limited to a value of the grayscale corresponding to white. For example, the setting luminance may be about 3000 nit. For example, the setting luminance may be about 600 nit. However, the present inventive concept is not limited to a value of the setting luminance.

The pixel PX may include a driving transistor configured to generate a driving current based on a data voltage VDATA and a high power voltage ELVDD, a write transistor configured to apply the data voltage VDATA to the driving transistor and a light emitting element including a first electrode receiving the driving current and the second electrode receiving a low power voltage ELVSS. In an embodiment, the pixel PX may further include an initialization transistor configured to apply an initialization voltage to a control electrode of the driving transistor.

The driving controller 200 may receive input image data IMG and an input control signal CONT from an external apparatus. For example, the input image data IMG may include red image data, green image data and blue image data. The input image data IMG may include white image data. The input image data IMG may include magenta image data, cyan image data and yellow image data. The input control signal CONT may include a master clock signal and a data enable signal. The input control signal CONT may further include a vertical synchronizing signal and a horizontal synchronizing signal.

The driving controller 200 may generate a first control signal CONT1, a second control signal CONT2, a third control signal CONT3, a fourth control signal CONT4, a fifth control signal CONT5 and a data signal DATA based on the input image data IMG and the input control signal CONT.

The driving controller 200 may generate the first control signal CONT1 for controlling an operation of the gate driver 300 based on the input control signal CONT, and output the first control signal CONT1 to the gate driver 300. The first control signal CONT1 may include a vertical start signal and a gate clock signal.

The driving controller 200 may generate the second control signal CONT2 for controlling an operation of the data driver 500 based on the input control signal CONT, and output the second control signal CONT2 to the data driver 500. The second control signal CONT2 may include a horizontal start signal and a load signal.

The driving controller 200 may generate the data signal DATA based on the input image data IMG. The driving controller 200 may output the data signal DATA to the data driver 500.

The driving controller 200 may generate the third control signal CONT3 for controlling an operation of the gamma reference voltage generator 400 based on the input control signal CONT, and output the third control signal CONT3 to the gamma reference voltage generator 400.

The driving controller 200 may generate the fourth control signal CONT4 for controlling an operation of the emission driver 600 based on the input control signal CONT, and output the fourth control signal CONT4 to the emission driver 600.

The driving controller 200 may generate the fifth control signal CONT5 for controlling an operation of the voltage generator 700 based on the input control signal CONT, and output the fifth control signal CONT5 to the voltage generator 700.

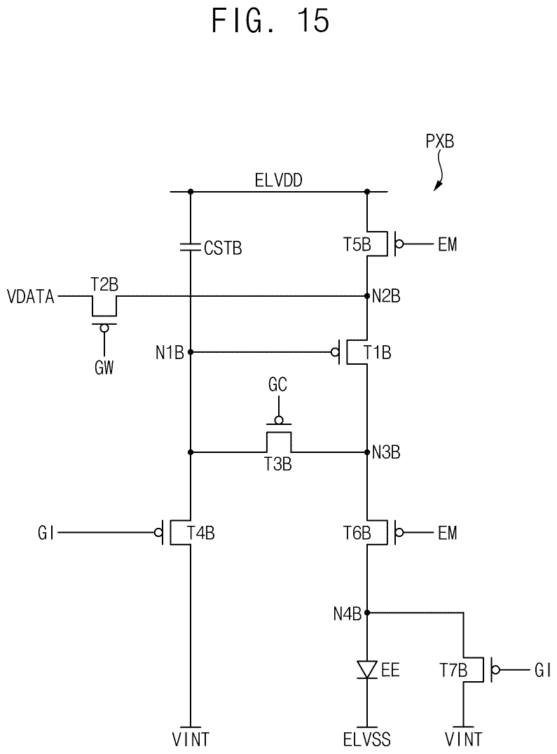

The gate driver 300 may generate gate signals driving the gate lines GL in response to the first control signal CONT1 received from the driving controller 200. The gate driver 300 may receive a gate high voltage and a gate low voltage from the voltage generator 700. The gate driver 300 may output the gate signals to the gate lines GL. For example, the gate signals may include an initialization gate signal GI of FIG. 15 and a write gate signal GW of FIG. 15. The gate signals may toggle between the gate high voltage and the gate low voltage.

In an embodiment, the gate driver 300 may be disposed in the peripheral region. In an embodiment, the gate driver 300 may be integrated in the peripheral region.

The gamma reference voltage generator 400 generates a gamma reference voltage VGREF in response to the third control signal CONT3 received from the driving controller 200. The gamma reference voltage generator 400 provides the gamma reference voltage VGREF to the data driver 500. The gamma reference voltage VGREF has a value corresponding to a level of the data signal DATA.

In an embodiment, the gamma reference voltage generator 400 may be disposed in the driving controller 200, or in the data driver 500.

The data driver 500 receives the second control signal CONT2 and the data signal DATA from the driving controller 200, and receives the gamma reference voltages VGREF from the gamma reference voltage generator 400. The data driver 500 converts the data signal DATA into data voltages VDATA having an analog type using the gamma reference voltages VGREF. The data driver 500 outputs the data voltages VDATA to the data lines DL. The data voltage VDATA may be a voltage such that the pixel PX emits light at a setting grayscale, i.e., emits light having an intensity corresponding to the setting grayscale. Based on a data voltage level of the data voltage VDATA, the pixel PX may emit at a grayscale corresponding to the data voltage level.

In an embodiment, the data driver 500 may be disposed in the peripheral region. In an embodiment, the data driver 500 may be integrated in the peripheral region.

The emission driver 600 may generate emission signal EM of FIG. 15 in response to the fourth control signal CONT4 received from the driving controller 200. The emission driver 600 may output the emission signal EM of FIG. 15 to the display panel 100.

In an embodiment, the emission driver 600 may be disposed in the peripheral region. In an embodiment, the emission driver 600 may be integrated in the peripheral region.

Although the gate driver 300 is disposed on a first side of the display panel 100, and the emission driver 600 is disposed on a second side of the display panel 100 in FIG. 1 for convenience of explanation, the present inventive concept is not limited thereto. The gate driver 300 and the emission driver 600 may be disposed on the first side of the display panel 100. For example, the gate driver 300 and the emission driver 600 may be disposed on the peripheral region of the display panel 100 on the same side of the display region of the display panel 100. For example, the gate driver 300 and the emission driver 600 may be formed integrally with each other.

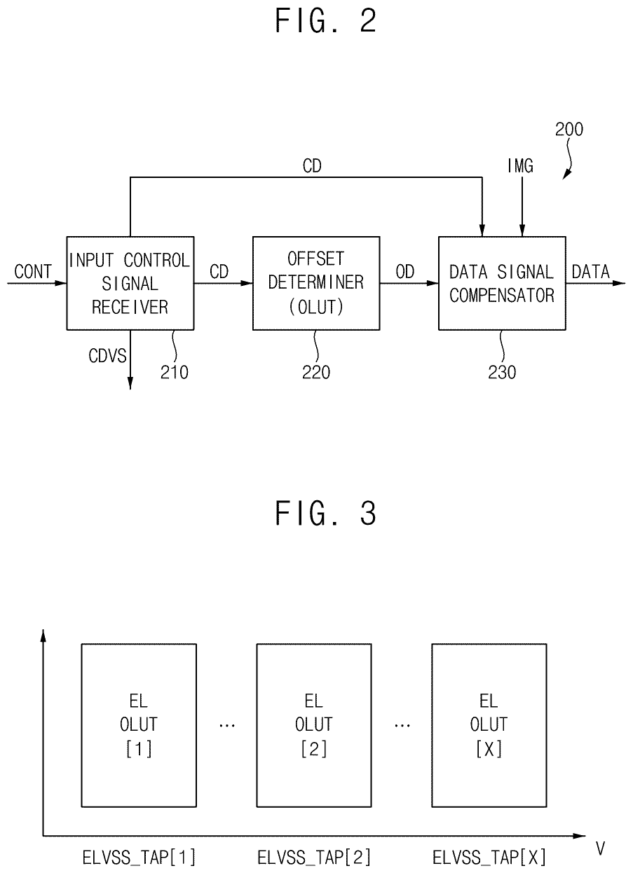

The voltage generator 700 may generate a plurality of driving voltages in responds to the fifth control signal CONT5 received from the driving controller 200. The driving voltages may include the high power voltage ELVDD, the low power voltage ELVSS, the gate high voltage, the gate low voltage and the initialization voltage VINT of FIG. 15. However, the present inventive concept is not limited to a voltage included in the driving voltages. The fifth control signal CONT5 may include a voltage generation control signal CDVS of FIG. 2.

In the present embodiment, the voltage generator 700 may change the driving voltage. The voltage generator 700 may change the driving voltage based on the setting luminance of the display panel 100. For example, when the setting luminance is changed from a first setting luminance to a second setting luminance, the voltage generator 700 may decrease a voltage level of at least one driving voltage of the driving voltages.

For example, the at least one driving voltage may be the low power voltage ELVSS. When the setting luminance is changed from a first setting luminance to a second setting luminance, the voltage generator 700 may decrease an absolute value of the low power voltage ELVSS. For example, when the setting luminance is changed from a first setting luminance to a second setting luminance, the voltage generator 700 may change the low power voltage ELVSS from about-5V to about-4V. However, the present inventive concept is not limited to a value of the low power voltage ELVSS.

For example, the at least one driving voltage may be the initialization voltage VINT of FIG. 15. When the setting luminance is changed from a first setting luminance to a second setting luminance, the voltage generator 700 may decrease an absolute value of the initialization voltage VINT of FIG. 15.

For example, the at least one driving voltage may be the gate low voltage. When the setting luminance is changed from a first setting luminance to a second setting luminance, the voltage generator 700 may decrease an absolute value of the gate low voltage.

For example, the at least one driving voltage may include the low power voltage ELVSS, be the initialization voltage VINT of FIG. 15 and the gate low voltage. When the setting luminance is changed from a first setting luminance to a second setting luminance, the voltage generator 700 may decrease absolute values of the low power voltage ELVSS, be the initialization voltage VINT of FIG. 15 and the gate low voltage. However, the present inventive concept is not limited to a type of the at least one driving voltage.

In the present embodiment, the driving voltages may be changed based on the setting luminance, so that a power consumption of the display device 1 may be reduced.

FIG. 2 is a block diagram illustrating an example of a driving controller 200 included in a display device 1.

Referring to FIG. 1 and FIG. 2, the driving controller 200 may include an input control signal receiver 210, an offset determiner 220 and a data signal compensator 230.

The input control signal receiver 210 may receive the input control signal CONT. The input control signal receiver 210 may output the voltage generation control signal CDVS and change data CD which mean a change of a driving voltage. The change of driving voltage may mean a difference in driving voltage that is changed based on a change of the setting luminance. For example, the change of driving voltage may mean a voltage level difference between a first driving voltage in a first setting luminance and a second driving voltage in a second setting luminance. For example, when the first driving voltage in the first setting luminance is about 4 V and the second driving voltage in the second setting luminance is about 3 V, the change of the driving voltage may be about 1 V. The change data CD may mean data on a difference in driving voltage based on the change in the setting luminance.

The offset determiner 220 may output offset data OD based on the change data CD. The offset data OD may be generated based on an offset look-up table OLUT corresponding to the change of the driving voltage. The offset look-up table OLUT may be stored in a manufacturing process of the display device 1. The offset look-up table OLUT may include offset voltages considering panel characteristic (e.g., a size of a display panel, a material of a display panel, and etc.). For example, the data voltage VDATA such that the pixel PX emits at the setting grayscale may be changed based on the panel characteristic. When it is said that a pixel emits, one of skill in the art will understand the term to mean that the pixel emits light. The offset voltage may be considered in data voltage VDATA, so that the pixel PX emits light at the setting grayscale.

For example, a first data voltage such that the pixel emits light at a first grayscale may be outputted. According to the panel characteristic, when the first data voltage is applied, the pixel PX may emit at a second grayscale different from the first grayscale. Accordingly, a display quality of a display panel may be deteriorated.

In the present embodiment, the data voltage VDATA applied to the pixel PX may be a voltage considered the offset voltage. For example, the offset voltage may be considered for the first data voltage such that the pixel PX emits light at the first grayscale. The first data voltage considering the offset voltage may be called as a first offset data voltage. When the first offset data voltage is applied to the pixel PX, the pixel PX may emit light at the first grayscale. In the present embodiment, the data voltage VDATA considering panel characteristics may be outputted. Accordingly, a display quality of the display panel 100 may be improved.

The offset look-up table OLUT may include the offset voltages corresponding to grayscale in which the pixel PX emits light. For example, the offset look-up table OLUT may include a first offset voltage corresponding to a first grayscale, a second offset voltage corresponding to a second grayscale, and a P-th offset voltage corresponding to a P-th grayscale where P is a positive integer. For example, the P-th grayscale may be about 255 grayscale level. However, the present inventive concept is not limited to a value of the maximum grayscale in which the pixel emits light. For example, in a manufacturing process of the display device 1, the offset voltage considering panel characteristics may be determined using a measuring device. In an embodiment, a multi-time programming MTP operation may be performed in the manufacturing process of the display device 1 to repeatedly correct the display device 1 in terms of luminance and/or color coordinates. A plurality of offset look-up tables OLUT may be generated through the multi-time programming operation. However, the present inventive concept is not limited to a method for generating a plurality of offset lookup tables OLUT.

The data signal compensator 230 may receive the change data CD and the offset data OD. The data signal compensator 230 may generate the data signal DATA considering a final offset voltage in the data voltage VDATA corresponding to the input image data IMG. The data signal compensator 230 may calculate the final offset voltage based on the change data CD and the offset data OD.

For example, when the data voltage corresponding to the input image data IMG applied to the pixel PX is a data voltage corresponding to about 10 grayscale level, the pixel PX may emit at a grayscale different from about 10 grayscale level according to the panel characteristics. Accordingly, a display quality of the display panel may be deteriorated.

For example, when the data voltage corresponding to the input image data IMG is a data voltage corresponding to about 10 grayscale level, and the data voltage corresponding to the input image data IMG considering the final offset voltage is a data voltage corresponding to about 20 grayscale level, the data signal compensator 230 may output a data signal DATA for emitting light as about 20 grayscale level. When the pixel PX receives the data voltage corresponding to the data signal DATA for emitting light as about 20 grayscale level, the pixel PX may emit light at about 10 grayscale level corresponding to the input image data IMG. In this way, the data signal DATA considering the panel characteristics to the input image data IMG may be generated. Accordingly, the display quality of the display panel 100 may be further improved.

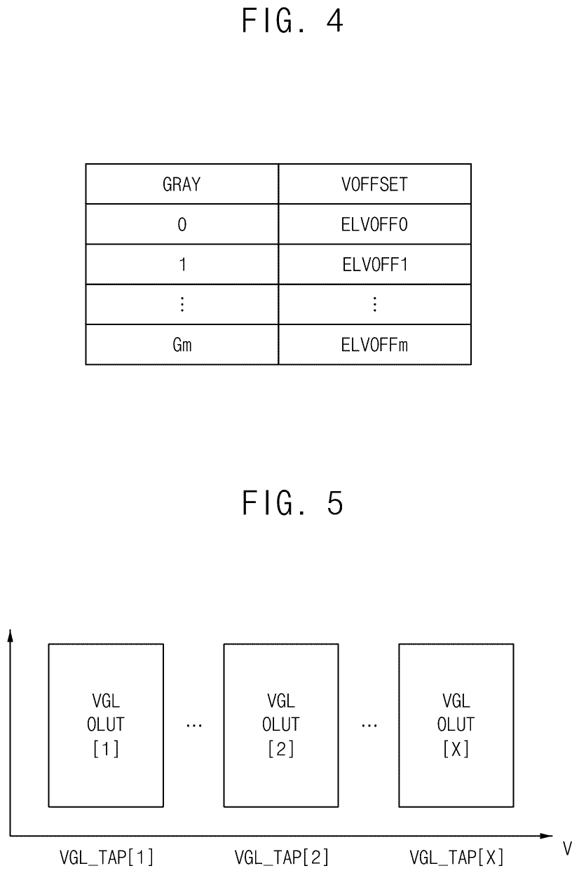

FIG. 3 is a diagram illustrating an example of a plurality of offset look-up tables OLUT stored in a driving controller 200 of FIG. 2. FIG. 4 is a table illustrating an example of an offset look-up table OLUT of FIG. 3.

Referring to FIG. 1 to FIG. 4, the driving controller 200 may store a plurality of the offset look-up tables OLUT. The offset determiner 220 of the driving controller 200 may store the plurality of the offset look-up tables OLUT. In the present embodiment, the plurality of the offset look-up tables OLUT may be low power voltage offset look-up tables ELOLUT[1], ELOLUT[2] to ELOLUT[X]. The offset determiner 220 may output a low power voltage offset data based on the low power voltage offset look-up tables ELOLUT[1], ELOLUT[2] to ELOLUT[X]. The low power voltage offset look-up tables ELOLUT[1], ELOLUT[2] to ELOLUT[X] may include first to X-th low power voltage offset look-up tables ELOLUT[1], ELOLUT[2] to ELOLUT[X]. The low power voltage offset look-up tables ELOLUT[1], ELOLUT[2] to ELOLUT[X] may be generated based on low power tap voltages ELVSS_TAP[1], ELVSS_TAP[2] and ELVSS_TAP[X].

For example, referring to FIG. 4, the offset look-up table OLUT may include low power offset voltages ELVoff0, ELVoff1 to ELVoffm corresponding to the low power voltage ELVSS considering the panel characteristic in the manufacturing process of the display device 1. The low power offset voltages ELVoff0, ELVoff1 to ELVoffm may have a value corresponding to each of grayscales, e.g., the 0 grayscale level to the maximum grayscale level Gm. For example, the low power offset voltages ELVoff0, ELVoff1 to ELVoffm corresponding to about 0 grayscale level to the maximum grayscale may be determined.

For example, the low power voltage ELVSS in a first setting luminance may be a first low power voltage. The first low power voltage may be called as a first low power tap voltage ELVSS_TAP[1]. The offset voltages in the first low power voltage considering the panel characteristic in the manufacturing process of the display device 1 may be determined. For example, the offset voltages in the first low power voltage considering the panel characteristic in the manufacturing process of the display device 1 may be determined using a measuring device. Accordingly, the first low power offset voltages corresponding to the first low power voltage may be determined. Accordingly, the first low power voltage offset look-up table ELOLUT[1] corresponding to the first low power voltage may be generated.

For example, the low power voltage ELVSS in a second setting luminance may be a second low power voltage different from the first low power voltage. The second low power voltage may be called as a second low power tap voltage ELVSS_TAP[2]. The offset voltages in the second low power voltage considering the panel characteristic in the manufacturing process of the display device 1 may be determined. For example, the offset voltages in the second low power voltage considering the panel characteristic in the manufacturing process of the display device 1 may be determined using a measuring device. Accordingly, the second low power offset voltages corresponding to the second low power voltage may be determined. Accordingly, the second low power voltage offset look-up table ELOLUT[2] corresponding to the second low power voltage may be generated.

For example, the low power voltage ELVSS in a first-first setting luminance which is between the first setting luminance and the second setting luminance may be a first-first low power voltage which is between the first low power voltage and the second low power voltage. First-first low power offset voltages corresponding to the first-first low power voltage may be determined through linear interpolation with the first low power offset voltages and the second low power offset voltages. For example, when the first low power voltage is about-5V, the second low power voltage is about-4V, the first-first low power voltage is about-4.5V, a first low power offset voltage corresponding to the first grayscale of the first low power offset voltages about 50 mV, and a second low power offset voltage corresponding to the first grayscale of the first low power offset voltages about 30 mV, the first-first low power offset voltage corresponding to the first grayscale of the first-first low power offset voltages in which the linear interpolation is performed may be about 40m V.

The first-first low power offset look-up table corresponding to the first-first low power voltage may be determined by performing linear interpolation with the first low power offset look-up table and the second low power offset look-up table. Accordingly, offset look-up tables may be generated without using a measuring device. Accordingly, the efficiency of the manufacturing process may be improved.

For example, the low power voltage ELVSS in a third setting luminance may be a third low power voltage different from the first low power voltage and the second low power voltage. The third low power voltage may be called as a third low power tap voltage. The offset voltages in the third low power voltage considering the panel characteristic in the manufacturing process of the display device 1 may be determined. For example, the offset voltages in the third low power voltage considering the panel characteristic in the manufacturing process of the display device 1 may be determined using a measuring device. Accordingly, the third low power offset voltages corresponding to the third low power voltage may be determined. Accordingly, the third low power voltage offset look-up table corresponding to the third low power voltage may be generated.

For example, the low power voltage ELVSS in an X-th setting luminance may be an X-th low power voltage different from the first to third low power voltages. The X-th low power voltage may be called as an X-th low power tap voltage ELVSS_TAP[X]. The offset voltages in the X-th low power voltage considering the panel characteristic in the manufacturing process of the display device 1 may be determined. For example, the offset voltages in the X-th low power voltage considering the panel characteristic in the manufacturing process of the display device 1 may be determined using a measuring device. Accordingly, the X-th low power offset voltages corresponding to the X-th low power voltage may be determined. Accordingly, the X-th low power voltage offset look-up table ELOLUT[X] corresponding to the X-th low power voltage may be generated.

In the present embodiment, some of the plurality of low power voltage offset look-up tables ELOLUT[1], ELOLUT[2] to ELOLUT[X] may be generated by performing linear interpolation. Accordingly, some of the offset lookup tables may be generated without using a measuring device. Accordingly, an efficiency of the manufacturing process may be improved.

Additionally, in the present embodiment, the low power voltage ELVSS may be changed according to a change of the setting luminance. For generating the data signal DATA according to a change in the low power voltage ELVSS, the low power voltage offset look-up tables ELOLUT[1], ELOLUT[2] to ELOLUT[X] may be generated. The data signal DATA may be generated based on the low power offset look-up table corresponding to the changed low power voltage ELVSS. Accordingly, the data signal DATA considering panel characteristics may be generated. Additionally, an influence due to the change of the low power voltage ELVSS according to the setting luminance may be considered. Accordingly, color distortion and/or luminance stability of the display panel 100 may be improved.

For example, the number of the low power tap voltages ELVSS_TAP[1], ELVSS_TAP[2] and ELVSS_TAP[X] may be set by the user. When the number of low power tap voltages ELVSS_TAP[1], ELVSS_TAP[2] and ELVSS_TAP[X] increases, the accuracy of low power offset look-up tables on which linear interpolation is performed may be improved. When the number of low power tap voltages ELVSS_TAP[1], ELVSS_TAP[2] and ELVSS_TAP[X] decreases, an efficiency of the manufacturing process may be improved.

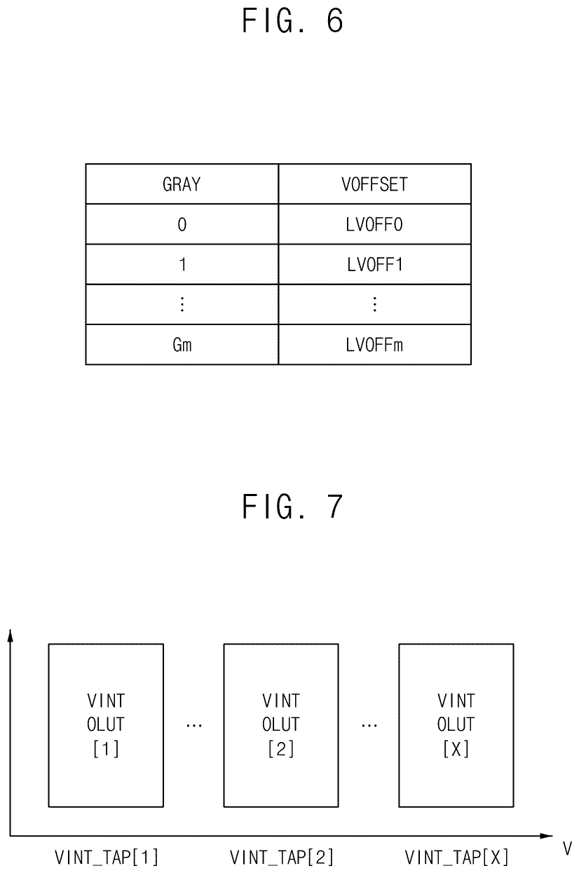

FIG. 5 is a diagram illustrating an example of a plurality of offset look-up tables OLUT stored in a driving controller 200 of FIG. 2. FIG. 6 is a table illustrating an example of an offset look-up table OLUT of FIG. 5.

Referring to FIG. 1 to FIG. 3, FIG. 5 and FIG. 6, the driving controller 200 may store a plurality of the offset look-up tables OLUT. The offset determiner 220 of the driving controller 200 may store the plurality of the offset look-up tables OLUT. In the present embodiment, the plurality of the offset look-up tables OLUT may be gate voltage offset look-up tables VGLOLUT[1], VGLOLUT[2] to VGLOLUT[X]. The offset determiner 220 may output gate voltage offset data based on the gate voltage offset look-up tables VGLOLUT[1], VGLOLUT[2] to VGLOLUT[X]. The gate voltage offset look-up tables VGLOLUT[1], VGLOLUT[2] to VGLOLUT[X] may include first to X-th gate voltage offset look-up tables VGLOLUT[1], VGLOLUT[2] to VGLOLUT[X]. The gate voltage offset look-up tables VGLOLUT[1], VGLOLUT[2] to VGLOLUT[X] may be generated based on gate tap voltages VGL_TAP[1], VGL_TAP[2] and VGL_TAP[X].

For example, referring to FIG. 6, the offset look-up table OLUT may include gate offset voltages LVoff0, LVoff1 to LVoffm corresponding to the gate voltage considering the panel characteristic in the manufacturing process of the display device 1. The gate offset voltages LVoff0, LVoff1 to LVoffm may have a value corresponding to each of grayscales. For example, the gate offset voltages LVoff0, LVoff1 to LVoffm corresponding to about 0 grayscale level to the maximum grayscale may be determined.

For example, the gate voltage in a first setting luminance may be a first gate voltage. The first gate voltage may be called as a first gate tap voltage VGL_TAP[1]. The offset voltages in the first gate voltage considering the panel characteristic in the manufacturing process of the display device 1 may be determined. For example, the offset voltages in the first gate voltage considering the panel characteristic in the manufacturing process of the display device 1 may be determined using a measuring device. Accordingly, the first gate offset voltages corresponding to the first gate voltage may be determined. Accordingly, the gate voltage offset look-up table VGLOLUT[1] corresponding to the first gate voltage may be generated.

For example, the gate voltage in a second setting luminance may be a second gate voltage different from the first gate voltage. The second gate voltage may be called as a second gate tap voltage VGL_TAP[2]. The offset voltages in the second gate voltage considering the panel characteristic in the manufacturing process of the display device 1 may be determined. For example, the offset voltages in the second gate voltage considering the panel characteristic in the manufacturing process of the display device 1 may be determined using a measuring device. Accordingly, the second gate offset voltages corresponding to the second gate voltage may be determined. Accordingly, the second gate voltage offset look-up table VGLOLUT[2] corresponding to the second gate voltage may be generated.

For example, the gate voltage in a first-first setting luminance which is between the first setting luminance and the second setting luminance may be a first-first gate voltage which is between the first gate voltage and the second gate voltage. First-first gate offset voltages corresponding to the first-first gate voltage may be determined through linear interpolation with the first gate offset voltages and the second gate offset voltages.

The first-first gate offset look-up table corresponding to the first-first gate voltage may be determined by performing linear interpolation with the first gate offset look-up table and the second gate offset look-up table. Accordingly, offset look-up tables may be generated without using a measuring device. Accordingly, the efficiency of the manufacturing process may be improved.

For example, the gate voltage in a third setting luminance may be a third gate voltage different from the first gate voltage and the second gate voltage. The third gate voltage may be called as a third gate tap voltage. The offset voltages in the third gate voltage considering the panel characteristic in the manufacturing process of the display device 1 may be determined. For example, the offset voltages in the third gate voltage considering the panel characteristic in the manufacturing process of the display device 1 may be determined using a measuring device. Accordingly, the third gate offset voltages corresponding to the third gate voltage may be determined. Accordingly, the third gate voltage offset look-up table corresponding to the third gate voltage may be generated.

For example, the gate voltage in an X-th setting luminance may be an X-th gate voltage different from the first to third gate voltages. The X-th gate voltage may be called as an X-th gate tap voltage VGL_TAP[X]. The offset voltages in the X-th gate voltage considering the panel characteristic in the manufacturing process of the display device 1 may be determined. For example, the offset voltages in the X-th gate voltage considering the panel characteristic in the manufacturing process of the display device 1 may be determined using a measuring device. Accordingly, the X-th gate offset voltages corresponding to the X-th gate voltage may be determined. Accordingly, the X-th gate voltage offset look-up table VGLOLUT[X] corresponding to the X-th gate voltage may be generated.

In the present embodiment, some of the plurality of gate voltage offset look-up tables VGLOLUT[1], VGLOLUT[2] to VGLOLUT[X] may be generated by performing linear interpolation. Accordingly, some of the offset lookup tables may be generated without using a measuring device. Accordingly, an efficiency of the manufacturing process may be improved.

Additionally, in the present embodiment, the gate voltage may be changed according to a change of the setting luminance. For generating the data signal DATA according to a change in the gate voltage, the gate voltage offset look-up tables VGLOLUT[1], VGLOLUT[2] to VGLOLUT[X] may be generated. The data signal DATA may be generated based on the gate offset look-up table corresponding to the changed gate voltage. Accordingly, the data signal DATA considering panel characteristics may be generated. Additionally, an influence due to the change of the gate voltage according to the setting luminance may be considered. Accordingly, color distortion and/or luminance stability of the display panel 100 may be improved. In the present embodiment, the gate voltage may be the gate low voltage. In an embodiment, the gate voltage may be the gate high voltage.

For example, the number of the gate tap voltages VGL_TAP[1], VGL_TAP[2] and VGL_TAP[X] may be set by the user. When the number of gate tap voltages VGL_TAP[1], VGL_TAP[2] and VGL_TAP[X] increases, the accuracy of gate offset look-up tables on which linear interpolation is performed may be improved. When the number of gate tap voltages VGL_TAP[1], VGL_TAP[2] and VGL_TAP[X] decreases, an efficiency of the manufacturing process may be improved.

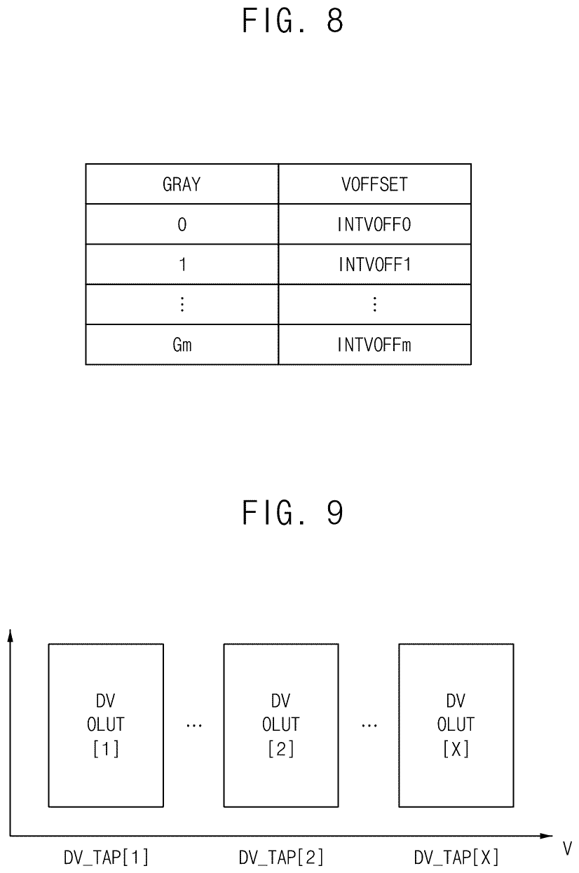

FIG. 7 is a diagram illustrating an example of a plurality of offset look-up tables OLUT stored in a driving controller 200 of FIG. 2. FIG. 8 is a table illustrating an example of an offset look-up table OLUT of FIG. 5.

Referring to FIG. 1 to FIG. 3, FIG. 7 and FIG. 8, the driving controller 200 may store a plurality of the offset look-up tables OLUT. The offset determiner 220 of the driving controller 200 may store the plurality of the offset look-up tables OLUT. In the present embodiment, the plurality of the offset look-up tables OLUT may be initialization voltage offset look-up tables VINTOLUT[1], VINTOLUT[2] to VINTOLUT[X]. The offset determiner 220 may output initialization voltage offset data based on the initialization voltage offset look-up tables VINTOLUT[1], VINTOLUT[2] to VINTOLUT[X]. The initialization voltage offset look-up tables VINTOLUT[1], VINTOLUT[2] to VINTOLUT[X] may include first to X-th initialization voltage offset look-up tables VINTOLUT[1], VINTOLUT[2] to VINTOLUT[X]. The initialization voltage offset look-up tables VINTOLUT[1], VINTOLUT[2] to VINTOLUT[X] may be generated based on initialization tap voltages VINT_TAP[1], VINT_TAP[2] and VINT_TAP[X].

For example, referring to FIG. 8, the offset look-up table OLUT may include initialization offset voltages INVoff0, INVoff1 to INVoffm corresponding to the initialization voltage considering the panel characteristic in the manufacturing process of the display device 1. The initialization offset voltages INVoff0, INVoff1 to INVoffm may have a value corresponding to each of grayscales. For example, the initialization offset voltages INVoff0, INVoff1 to INVoffm corresponding to about 0 grayscale level to the maximum grayscale may be determined.

For example, the initialization voltage in a first setting luminance may be a first initialization voltage. The first initialization voltage may be called as a first initialization tap voltage VINT_TAP[1]. The offset voltages in the first initialization voltage considering the panel characteristic in the manufacturing process of the display device 1 may be determined. For example, the offset voltages in the first initialization voltage considering the panel characteristic in the manufacturing process of the display device 1 may be determined using a measuring device. Accordingly, the first initialization offset voltages corresponding to the first initialization voltage may be determined. Accordingly, the initialization voltage offset look-up table VINTOLUT[1] corresponding to the first initialization voltage may be generated.

For example, the initialization voltage in a second setting luminance may be a second initialization voltage different from the first initialization voltage. The second initialization voltage may be called as a second initialization tap voltage VINT_TAP[2]. The offset voltages in the second initialization voltage considering the panel characteristic in the manufacturing process of the display device 1 may be determined. For example, the offset voltages in the second initialization voltage considering the panel characteristic in the manufacturing process of the display device 1 may be determined using a measuring device. Accordingly, the second initialization offset voltages corresponding to the second initialization voltage may be determined. Accordingly, the second initialization voltage offset look-up table VINTOLUT[2] corresponding to the second initialization voltage may be generated.

For example, the initialization voltage in a first-first setting luminance which is between the first setting luminance and the second setting luminance may be a first-first initialization voltage which is between the first initialization voltage and the second initialization voltage. First-first initialization offset voltages corresponding to the first-first initialization voltage may be determined through linear interpolation with the first initialization offset voltages and the second initialization offset voltages.

The first-first initialization offset look-up table corresponding to the first-first initialization voltage may be determined by performing linear interpolation with the first initialization offset look-up table and the second initialization offset look-up table. Accordingly, offset look-up tables may be generated without using a measuring device. Accordingly, the efficiency of the manufacturing process may be improved.

For example, the initialization voltage in a third setting luminance may be a third initialization voltage different from the first initialization voltage and the second gate voltage. The third initialization voltage may be called as a third initialization tap voltage. The offset voltages in the third initialization voltage considering the panel characteristic in the manufacturing process of the display device 1 may be determined. For example, the offset voltages in the third initialization voltage considering the panel characteristic in the manufacturing process of the display device 1 may be determined using a measuring device. Accordingly, the third initialization offset voltages corresponding to the third initialization voltage may be determined. Accordingly, the third initialization voltage offset look-up table corresponding to the third initialization voltage may be generated.

For example, the initialization voltage in an X-th setting luminance may be an X-th initialization voltage different from the first to third initialization voltages. The X-th initialization voltage may be called as an X-th initialization tap voltage VINT_TAP[X]. The offset voltages in the X-th initialization voltage considering the panel characteristic in the manufacturing process of the display device 1 may be determined. For example, the offset voltages in the X-th initialization voltage considering the panel characteristic in the manufacturing process of the display device 1 may be determined using a measuring device. Accordingly, the X-th initialization offset voltages corresponding to the X-th initialization voltage may be determined. Accordingly, the X-th initialization voltage offset look-up table VINTOLUT[X] corresponding to the X-th initialization voltage may be generated.

In the present embodiment, some of the plurality of initialization voltage offset look-up tables VINTOLUT[1], VINTOLUT[2] to VINTOLUT[X] may be generated by performing linear interpolation. Accordingly, some of the offset lookup tables may be generated without using a measuring device. Accordingly, an efficiency of the manufacturing process may be improved.

Additionally, in the present embodiment, the initialization voltage may be changed according to a change of the setting luminance. For generating the data signal DATA according to a change in the initialization voltage, the initialization voltage offset look-up tables VINTOLUT[1], VINTOLUT[2] to VINTOLUT[X] may be generated. The data signal DATA may be generated based on the initialization offset look-up table corresponding to the changed initialization voltage. Accordingly, the data signal DATA considering panel characteristics may be generated. Additionally, an influence due to the change of the initialization voltage according to the setting luminance may be considered. Accordingly, color distortion and/or luminance stability of the display panel 100 may be improved.

For example, the number of the initialization tap voltages VINT_TAP[1], VINT_TAP[2] and VINT_TAP[X] may be set by the user. When the number of initialization tap voltages VINT_TAP[1], VINT_TAP[2] and VINT_TAP[X] increases, the accuracy of initialization offset look-up tables on which linear interpolation is performed may be improved. When the number of initialization tap voltages VINT_TAP[1], VINT_TAP[2] and VINT_TAP[X] decreases, an efficiency of the manufacturing process may be improved.

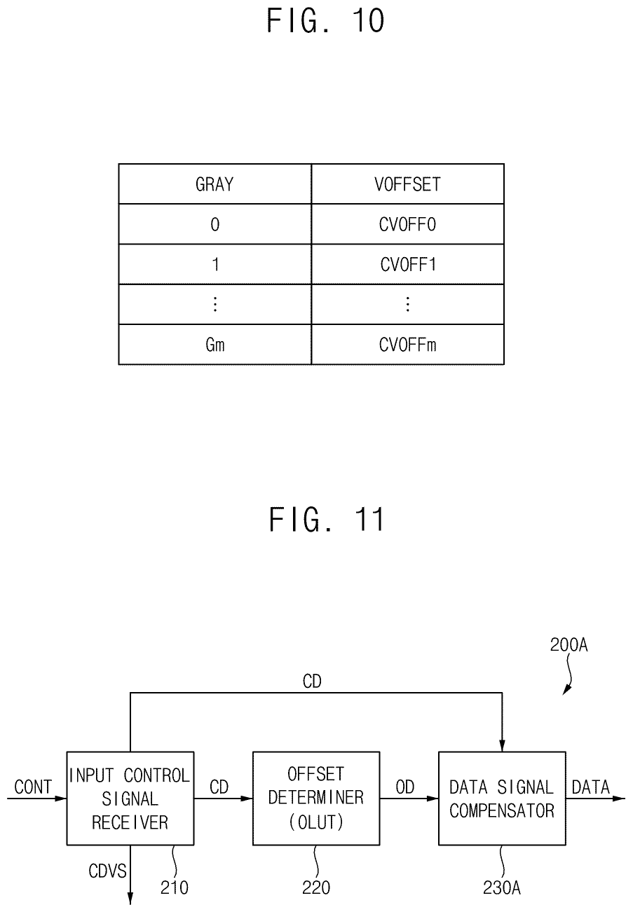

FIG. 9 is a diagram illustrating an example of a plurality of offset look-up tables OLUT stored in a driving controller 200 of FIG. 2. FIG. 10 is a table illustrating an example of an offset look-up table OLUT of FIG. 5.

Referring to FIG. 1 to FIG. 3, FIG. 9 and FIG. 10, the driving controller 200 may store a plurality of the offset look-up tables OLUT. The offset determiner 220 of the driving controller 200 may store the plurality of the offset look-up tables OLUT. In the present embodiment, the plurality of the offset look-up tables OLUT may be driving voltage offset look-up tables DVOLUT[1], DVOLUT[2] to DVOLUT[X]. The offset determiner 220 may output driving voltage offset data based on the driving voltage offset look-up tables DVOLUT[1], DVOLUT[2] to DVOLUT[X]. The driving voltage offset look-up tables DVOLUT[1], DVOLUT[2] to DVOLUT[X] may include first to X-th driving voltage offset look-up tables DVOLUT[1], DVOLUT[2] to DVOLUT[X]. The driving voltage offset look-up tables DVOLUT[1], DVOLUT[2] to DVOLUT[X] may be generated based on driving tap voltages DV_TAP[1], DV_TAP[2] and DV_TAP[X]. The driving voltage offset look-up table may be called as an integration offset look-up table.

For example, referring to FIG. 10, the offset look-up table OLUT may include driving offset voltages CVoff0, CVoff1 to CVoffm corresponding to the driving voltage considering the panel characteristic in the manufacturing process of the display device 1. The driving offset voltages CVoff0, CVoff1 to CVoffm may have a value corresponding to each of grayscales. For example, the driving offset voltages CVoff0, CVoff1 to CVoffm corresponding to about 0 grayscale level to the maximum grayscale may be determined. In the present embodiment, the driving voltage may include the high power voltage ELVDD, the low power voltage ELVSS, the gate high voltage, the gate low voltage and the initialization voltage. In the present embodiment, when the setting luminance is changed, the driving voltage may be changed. In the present embodiment, when the setting luminance is changed, the driving voltage may be changed, so that the high power voltage ELVDD, the low power voltage ELVSS, the gate high voltage, the gate low voltage and the initialization voltage may be changed.

For example, the driving voltage in a first setting luminance may be a first driving voltage. The first driving voltage may include a first high power voltage, a first low power voltage, a first gate high voltage, a first gate low voltage and a first initialization voltage. The first driving voltage may be called as a first driving tap voltage DV_TAP[1]. The offset voltages in the first driving voltage considering the panel characteristic in the manufacturing process of the display device 1 may be determined. The offset voltages in the first high power voltage, the first low power voltage, the first gate high voltage, the first gate low voltage and the first initialization voltage considering the panel characteristic in the manufacturing process of the display device 1 may be determined.

For example, the offset voltages in the first driving voltage considering the panel characteristic in the manufacturing process of the display device 1 may be determined using a measuring device. Accordingly, the first driving offset voltages corresponding to the first driving voltage may be determined. Accordingly, the driving voltage offset look-up table DVOLUT[1] corresponding to the first driving voltage may be generated.

For example, the driving voltage in a second setting luminance may be a second driving voltage. The second driving voltage may include a second high power voltage, a second low power voltage, a second gate high voltage, a second gate low voltage and a second initialization voltage. The second driving voltage may be called as a second driving tap voltage DV_TAP[2]. The offset voltages in the second driving voltage considering the panel characteristic in the manufacturing process of the display device 1 may be determined. The offset voltages in the second high power voltage, the second low power voltage, the second gate high voltage, the second gate low voltage and the second initialization voltage considering the panel characteristic in the manufacturing process of the display device 1 may be determined.

For example, the driving voltage in a first-first setting luminance which is between the first setting luminance and the second setting luminance may be a first-first driving voltage which is between the first driving voltage and the second driving voltage. First-first driving offset voltages corresponding to the first-first driving voltage may be determined through linear interpolation with the first driving offset voltages and the second driving offset voltages.

The first-first driving offset look-up table corresponding to the first-first driving voltage may be determined by performing linear interpolation with the first driving offset look-up table and the second driving offset look-up table. Accordingly, offset look-up tables may be generated without using a measuring device. Accordingly, the efficiency of the manufacturing process may be improved.

For example, the driving voltage in a third setting luminance may be a third driving voltage. The third driving voltage may include a third high power voltage, a third low power voltage, a third gate high voltage, a third gate low voltage and a third initialization voltage. The third driving voltage may be called as a third driving tap voltage. The offset voltages in the third driving voltage considering the panel characteristic in the manufacturing process of the display device 1 may be determined. The offset voltages in the third high power voltage, the third low power voltage, the third gate high voltage, the third gate low voltage and the third initialization voltage considering the panel characteristic in the manufacturing process of the display device 1 may be determined.

For example, the driving voltage in an X-th setting luminance may be an X-th driving voltage. The X-th driving voltage may include an X-th high power voltage, an X-th low power voltage, an X-th gate high voltage, an X-th gate low voltage and an X-th initialization voltage. The X-th driving voltage may be called as an X-th driving tap voltage DV_TAP[X]. The offset voltages in the X-th driving voltage considering the panel characteristic in the manufacturing process of the display device 1 may be determined. The offset voltages in the X-th high power voltage, the X-th low power voltage, the second gate high voltage, the X-th gate low voltage and the X-th initialization voltage considering the panel characteristic in the manufacturing process of the display device 1 may be determined.

In the present embodiment, some of the plurality of driving voltage offset look-up tables DVOLUT[1], DVOLUT[2] to DVOLUT[X] may be generated by performing linear interpolation. Accordingly, some of the offset lookup tables may be generated without using a measuring device. Accordingly, an efficiency of the manufacturing process may be improved.

Additionally, in the present embodiment, the driving voltage may be changed according to a change of the setting luminance. For generating the data signal DATA according to a change in the initialization voltage, the driving voltage offset look-up tables DVOLUT[1], DVOLUT[2] to DVOLUT[X] may be generated. The data signal DATA may be generated based on the driving offset look-up table corresponding to the changed driving voltage. Accordingly, the data signal DATA considering panel characteristics may be generated. Additionally, an influence due to the change of the driving voltage according to the setting luminance may be considered. Accordingly, color distortion and/or luminance stability of the display panel 100 may be improved.

For example, the number of the driving tap voltages DV_TAP[1], DV_TAP[2] and DV_TAP[X] may be set by the user. When the number of driving tap voltages DV_TAP[1], DV_TAP[2] and DV_TAP[X] increases, the accuracy of initialization offset look-up tables on which linear interpolation is performed may be improved. When the number of driving tap voltages DV_TAP[1], DV_TAP[2] and DV_TAP[X] decreases, an efficiency of the manufacturing process may be improved.

Additionally, in the present embodiment, the data signal DATA may be generated based on the integration offset look-up table. Accordingly, the influence of changes of the high power voltage ELVDD, the low power voltage ELVSS, the gate high voltage, the gate low voltage and the initialization voltage may be considered. Accordingly, a display quality of the display panel 100 may be further improved. Additionally, the data signal DATA may be generated based on the integration offset look-up table, so that the storage efficiency of the offset determiner 220 in which the integration offset look-up table is stored may be improved.

FIG. 11 is a block diagram illustrating an example of a driving controller 200A included in the display device 1 of FIG. 1.

The driving controller 200A of FIG. 11 is substantially same as the driving controller 200 of FIG. 2 except for an operation of a data signal compensator 230A, so that the same reference numerals will be used and any repetitive explanation concerning the above elements will be omitted.

Referring to FIG. 1 to FIG. 11, the data signal compensator 230A may receive the change data CD and the offset data OD. The data signal compensator 230A may generate the data signal DATA considering a final offset voltage in the data voltage VDATA corresponding to the input image data IMG. The data signal compensator 230A may calculate the final offset voltage based on the change data CD, the offset data OD and a voltage difference between a data voltage of a reference grayscale and a data voltage of the setting grayscale. The data voltage of the reference grayscale may be a data voltage such that the pixel PX emits as the reference grayscale. In an embodiment, the reference grayscale may be the maximum grayscale. For example, the maximum grayscale may be about 255 grayscale level. However, the present inventive concept is not limited to a value of the maximum grayscale. The data voltage of the setting luminance may be a data voltage such that pixel PX emits as the setting grayscale corresponding to the input image data IMG.

In an embodiment, the data signal compensator 230A may calculate the final offset voltage based on a first equation

$$V foff = Δ D V * offset ( Gray ) * ( V {data}_{R E F} - V {data}_{G r a y} ) \qquad [ first equation ]$$

Herein the Vfoff is the final offset voltage, the ΔDV is the change of the at least one driving voltage, the offset(Gray) is a voltage corresponding to the offset data and the Vdata_{REF}−Vdata_{Gray} is the voltage difference.

For example, the data signal DATA may include a first data signal for outputting a data voltage corresponding to a first grayscale and a second data signal for outputting a data voltage corresponding to a second grayscale higher than the first grayscale. The first data signal may be generated based on the voltage difference, the change data CD and the offset data OD. The second data signal may be generated based on the voltage difference and the offset data OD.

In the present embodiment, the voltage difference between the data voltage of the reference grayscale and the data voltage of the setting grayscale may be considered in the final offset voltage. The voltage difference between the data voltage of the reference grayscale and the data voltage of the setting grayscale may be considered in the final offset voltage, so that a tendency of the gamma curve may be reflected in the data voltage VDATA generated based on the data signal DATA. Accordingly, a display quality of the display panel 100 may be further improved. For example, a method of considering the voltage difference between the data voltage of the reference grayscale and the data voltage of the set grayscale may be called as a normalization method.

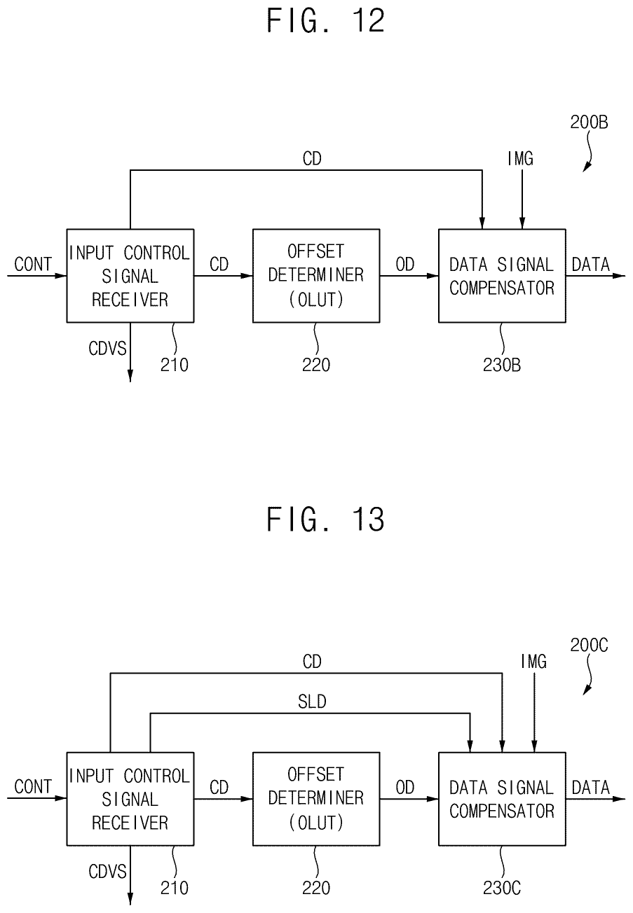

FIG. 12 is a block diagram illustrating an example of a driving controller 200B included in the display device 1 of FIG. 1.

The driving controller 200B of FIG. 12 is substantially same as the driving controller 200 of FIG. 2 except for an operation of a data signal compensator 230B, so that the same reference numerals will be used and any repetitive explanation concerning the above elements will be omitted.

Referring to FIG. 1 to FIG. 10 and FIG. 12, the data signal compensator 230B may receive the change data CD and the offset data OD. The data signal compensator 230B may generate the data signal DATA considering a final offset voltage in the data voltage VDATA corresponding to the input image data IMG. The data signal compensator 230B may calculate the final offset voltage based on the change data CD, the offset data OD, a voltage coefficient and a voltage difference between a data voltage of a reference grayscale and a data voltage of the setting grayscale. The data voltage of the reference grayscale may be a data voltage such that the pixel PX emits as the reference grayscale. In an embodiment, the reference grayscale may be the maximum grayscale. For example, the maximum grayscale may be about 255 grayscale level. However, the present inventive concept is not limited to a value of the maximum grayscale. The data voltage of the setting luminance may be a data voltage such that pixel PX emits as the setting grayscale corresponding to the input image data IMG. The voltage coefficient may be set by user.

When the voltage level of the offset voltage considering the panel characteristics is high, the data capacity for storing the offset voltage may increase. Accordingly, the storage efficiency of the offset determiner 220 may be decreased. In the present embodiment, the voltage coefficient may have a different value based on the voltage level of the offset voltage. Accordingly, the voltage level of the offset voltage considering the panel characteristics may be lowered and stored, and the final offset voltage may be calculated by multiplying the lowered and stored offset voltage by the voltage coefficient. Accordingly, the storage efficiency of the offset determiner 220 may be further improved.

In an embodiment, the data signal compensator 230B may calculate the final offset voltage based on a second equation

$$V foff = Δ D V * offset ( Gray ) * ( V {data}_{R E F} - V {data}_{G r a y} ) * k \qquad [ second equation ]$$

Herein the Vfoff is the final offset voltage, the ΔDV is the change of the at least one driving voltage, the offset(Gray) is a voltage corresponding to the offset data, the Vdata_{REF}−Vdata_{Gray} is the voltage difference, and k is the voltage coefficient.

For example, the data signal DATA may include a first data signal for outputting a data voltage corresponding to a first grayscale and a second data signal for outputting a data voltage corresponding to a second grayscale higher than the first grayscale. The first data signal may be generated based on the voltage difference, the change data CD and the offset data OD. The second data signal may be generated based on the voltage difference and the offset data OD.

In the present embodiment, the voltage difference between the data voltage of the reference grayscale and the data voltage of the setting grayscale may be considered in the final offset voltage. The voltage difference between the data voltage of the reference grayscale and the data voltage of the setting grayscale may be considered in the final offset voltage, so that a tendency of the gamma curve may be reflected in the data voltage VDATA generated based on the data signal DATA. Accordingly, a display quality of the display panel 100 may be further improved. For example, a method of considering the voltage difference between the data voltage of the reference grayscale and the data voltage of the set grayscale may be called as a normalization method.

Additionally, the voltage level of the offset voltage may be lowered and stored considering the panel characteristics, and the final offset voltage may be calculated by multiplying the lowered and stored offset voltage by the voltage coefficient. Accordingly, the storage efficiency of the offset determiner 220 may be further improved.

FIG. 13 is a block diagram illustrating an example of a driving controller 200C included in the display device 1 of FIG. 1.

The driving controller 200C of FIG. 13 is substantially same as the driving controller 200 of FIG. 2 except that a data signal compensator 230C may further receive a setting luminance data SLD, and an operation of a data signal compensator 230C, so that the same reference numerals will be used and any repetitive explanation concerning the above elements will be omitted.

Referring to FIG. 1 to FIG. 10 and FIG. 13, the data signal compensator 230C may receive the change data CD, the offset data OD and the setting luminance data SLD. The setting luminance data SLD may be data of the setting luminance of the display panel 100.

The data signal compensator 230C may generate the data signal DATA considering a final offset voltage in the data voltage VDATA corresponding to the input image data IMG.

When the setting luminance is lower than the reference luminance, the data signal compensator 230C may calculate the final offset voltage based on the change data CD, the offset data OD and a voltage difference between a data voltage of a reference grayscale and a data voltage of the setting grayscale. The data voltage of the reference grayscale may be a data voltage such that the pixel PX emits as the reference grayscale. In an embodiment, the reference grayscale may be the maximum grayscale. For example, the maximum grayscale may be about 255 grayscale level. However, the present inventive concept is not limited to a value of the maximum grayscale. The data voltage of the setting luminance may be a data voltage such that pixel PX emits as the setting grayscale corresponding to the input image data IMG. The reference luminance may be set by user.

When the setting luminance is higher than the reference luminance, the data signal compensator 230C may calculate the final offset voltage based on a voltage difference between a data voltage of a reference grayscale and a data voltage of the setting grayscale, the change data CD and the offset data OD.

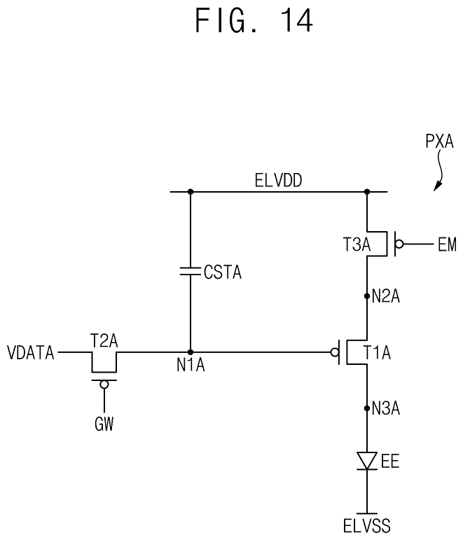

FIG. 14 is a circuit diagram illustrating an example of a pixel PXA included the display device 1 of FIG. 1.

Referring to FIG. 1 and FIG. 14, the pixel PXA may include first to third transistors T1A, T2A and T3A, a storage capacitor CSTA and a light emitting element EE.

The first transistor T1A may include a control electrode connected to a first node NIA, a first electrode connected to a second node N2A and a second electrode connected to a third node N3A. The first transistor T1A may generate a driving current based on a voltage of the first node NIA. For example, the first transistor T1A may be called a driving transistor.

The second transistor T2A may include a control electrode receiving a writing gate signal GW, a first electrode receiving the data voltage VDATA and a second electrode connected to the first node NIA. The second transistor T2A may apply the data voltage VDATA to the first node NIA in response to the write gate signal GW. For example, the second transistor T2A may be called a writing transistor.

The third transistor T3A may include a control electrode receiving the emission signal EM, a first electrode receiving the high power voltage ELVDD and a second electrode connected to the second node N2A. The third transistor T3A may apply the high power voltage ELVDD to the second node N2A in response to the emission signal EM. For example, the third transistor T3A may be called an emission transistor.

The storage capacitor CST may include a first electrode receiving the high power voltage ELVDD and a second electrode connected to the first node NIA. The storage capacitor CSTA may store a voltage of the first node NIA.

The light emitting element EE may include a first electrode connected to the third node N3A and a second electrode receiving the low power voltage ELVSS. The light emitting element EE may emit light based on the driving current.

FIG. 15 is a circuit diagram illustrating an example of pixel PXB included in the display device 1 of FIG. 1.

Referring to FIG. 1 and FIG. 15, the pixel PXB may include a first transistor T1B, a second transistor T2B, a third transistor T3B, a fourth transistor T4B, a fifth transistor T5B, a sixth transistor T6B, a seventh transistor T7B, a storage capacitor CSTB and the light emitting element EE.

The first transistor TIB may include a control electrode connected to a first node N1B, a first electrode connected to a second node N2B and a second electrode connected to a third node N3B. The first transistor TIB may generate a driving current based on a voltage of the first node NIB. For example, the first transistor TIB may be called the driving transistor.

The second transistor T2B may include a control electrode receiving a write gate signal GW, a first electrode receiving the data voltage VDATA and a second electrode connected to the second node N2B. The second transistor T2B may apply the data voltage VDATA to the second node N2B in response to the write gate signal GW. For example, the second transistor T2B may be called the writing transistor.

The third transistor T3B may include a control electrode receiving the compensation gate signal GC, a first electrode connected to the third node N3B and a second electrode connected to the first node NIB. The third transistor T3B may connect the first node NIB and the third node N3B in response to the compensation gate signal GC. For example, the third transistor T3B may diode-connect the first transistor T1B in response to the compensation gate signal GC. For example, the third transistor T3B may be called the compensation transistor.

The fourth transistor T4B may include a control electrode receiving the initialization gate signal GI, a first electrode receiving the initialization voltage VINT and a second electrode connected to the first node NIB. The fourth transistor T4B may apply the initialization voltage VINT to the first node NIB in response to the initialization gate signal GI. For example, the fourth transistor T4B may be called the initialization transistor.

The fifth transistor T5B may include a control electrode receiving the emission signal EM, a first electrode receiving the high power voltage ELVDD and a second electrode connected to the second node N2B. The fifth transistor T5B may apply the high power voltage ELVDD to the second node N2B in response to the emission signal EM. For example, the fifth transistor T5B may be called a second emission transistor.

The sixth transistor T6B may include a control electrode receiving the emission signal EM, a first electrode connected to the third node N3B and a second electrode connected to a fourth node N4B. The sixth transistor T6B may connect the third node N3B and the fourth node N4B in response to the emission signal EM. For example, the sixth transistor T6B may be called a first emission transistor.

The seventh transistor T7B may include a control electrode receiving the initialization gate signal GI, a first electrode receiving the initialization voltage VINT and a second electrode connected to the fourth node N4B. The seventh transistor T7B may apply the initialization voltage VINT to the fourth node N4B in response to the initialization gate signal GI.

The storage capacitor CSTB may include a first electrode receiving the high power voltage ELVDD and a second electrode connected to the first node NIB. The storage capacitor CSTB may store a voltage of the first node N1B.

The light emitting element EE may include a first electrode connected to the fourth node N4B and a second electrode receiving the low power voltage ELVSS. The light emitting element EE may emit light based on the driving current.

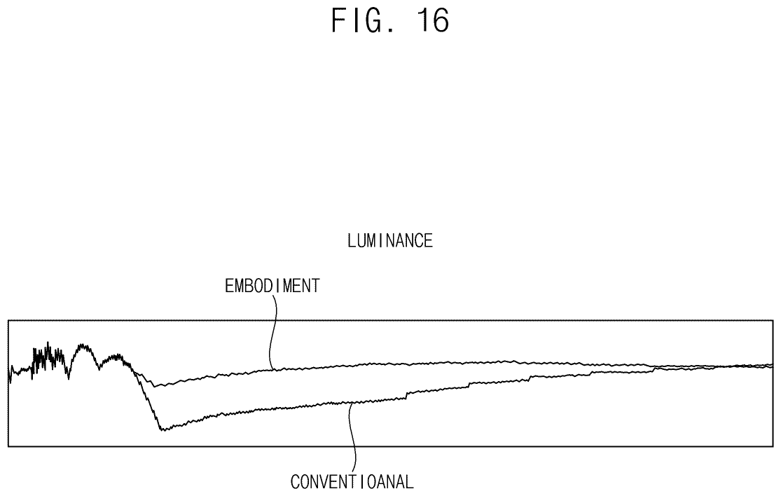

FIG. 16 is a graph illustrating a target luminance according to embodiments.

Referring to FIG. 1 to FIG. 16, the driving controller 200 may generate the data signal DATA based on the final offset voltage. The data driver 500 may output the data voltage VDATA based on the data signal DATA. The display panel 100 may emit light based on the data voltage VDATA. Compared to a conventional display device, the display device 1 according to the present inventive concept may reduce a decrease in luminance from a target luminance. Accordingly, the display quality of the display panel 100 may be improved.

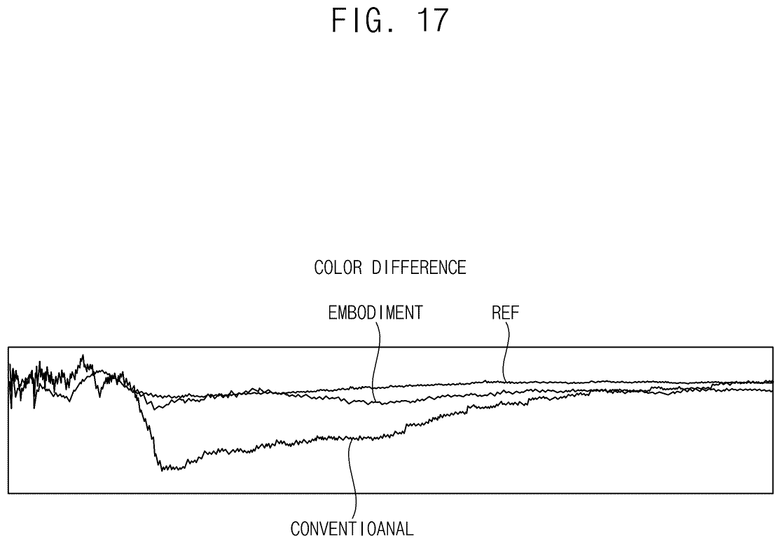

FIG. 17 is a graph illustrating a color difference according to embodiments.

Referring to FIG. 1 to FIG. 17, the driving controller 200 may generate the data signal DATA based on the final offset voltage. The data driver 500 may output the data voltage VDATA based on the data signal DATA. The display panel 100 may emit light based on the data voltage VDATA. Compared to a conventional display device, the display device 1 according to the present inventive concept may have a reduced color difference from the reference color REF. Accordingly, the display quality of the display panel 100 may be improved.

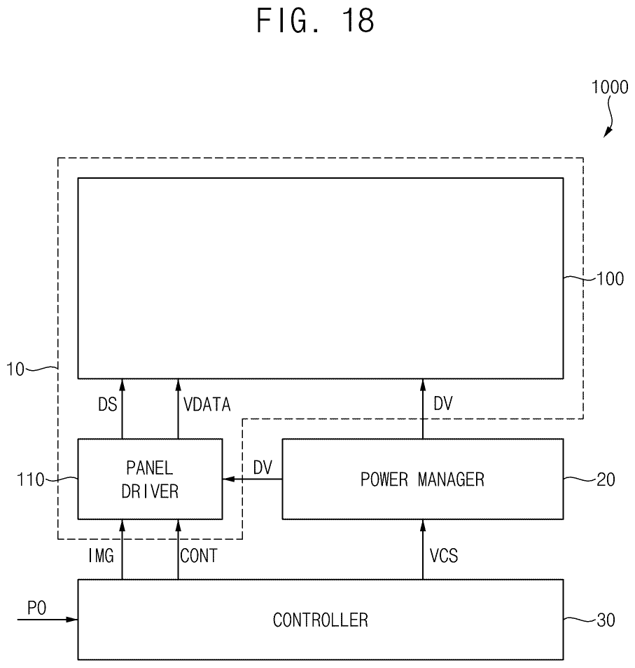

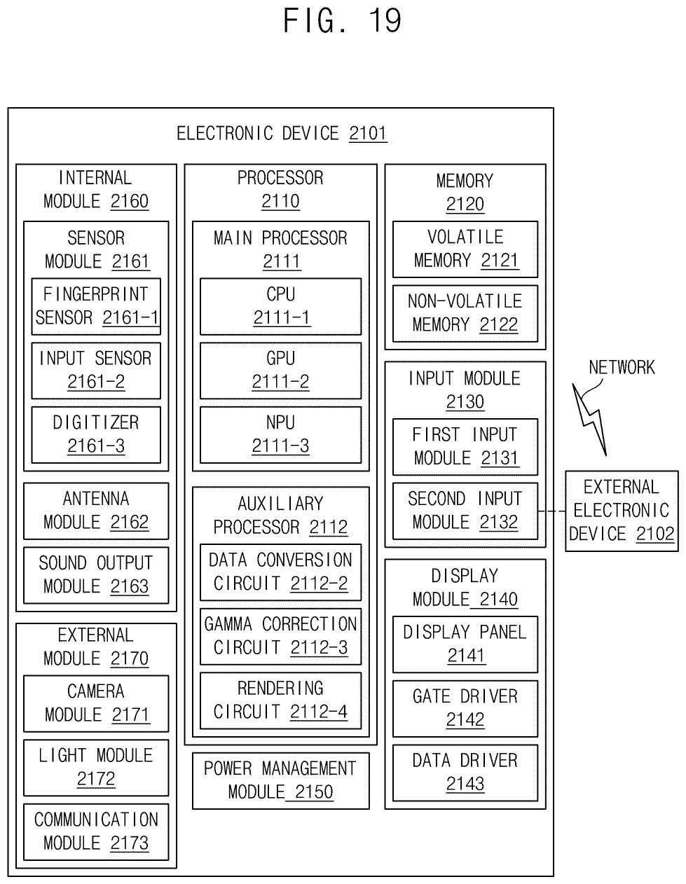

FIG. 18 is a block diagram illustrating an electronic device 1000 according to an embodiment.

Referring to FIG. 2 to FIG. 18, the electronic device 1000 may include a display module 10, a power manager 20 and a controller 30. The display module 10 may be substantially same as the display device 1 of FIG. 1. The display module 10 may include the display panel 100 and the panel driver 110.

The controller 30 may output the input image data IMG and the input control signal CONT to the panel driver 100 in response to a power-on signal PO. The controller 30 may output the voltage control signal VCS in response to the power-on signal PO.

The power manager 20 may output the driving voltage DV to the panel driver 110 and the display panel 100 based on the voltage control signal VCS. In an embodiment, the voltage control signal VCS may include data of the setting luminance. When the setting luminance is changed, the power manager 20 may change a voltage level of the driving voltage DV in response to the voltage control signal VCS.

The panel driver 110 may generate driving signals DS and the data voltage VDATA based on the driving voltage DV. The panel driver 110 may output the driving signals DS and the data voltage VDATA to the display panel 100.

The display panel 100 may emit based on the driving signal DS, the driving voltage DV and the data voltage VDATA.

In the present embodiment, some of the plurality of driving voltage offset look-up tables DVOLUT[1], DVOLUT[2] to DVOLUT[X] may be generated by performing linear interpolation. Accordingly, some of the offset lookup tables may be generated without using a measuring device. Accordingly, an efficiency of the manufacturing process may be improved.

Additionally, in the present embodiment, the driving voltage may be changed according to a change of the setting luminance. For generating the data signal DATA according to a change in the initialization voltage, the driving voltage offset look-up tables DVOLUT[1], DVOLUT[2] to DVOLUT[X] may be generated. The data signal DATA may be generated based on the driving voltage offset look-up table corresponding to the changed driving voltage. Accordingly, the data signal DATA considering panel characteristics may be generated. Additionally, an influence due to the change of the driving voltage according to the setting luminance may be considered. Accordingly, color distortion and/or luminance stability of the display panel 100 may be improved.

FIG. 19 is a block diagram illustrating an electronic device 2101 according to an embodiment.

Referring to FIG. 1 to FIG. 19 the electronic device 2101 may output various information via a display module 2140 in an operating system. When a processor 2110 executes an application stored in a memory 2120, the display module 2140 may provide application information to a user via a display panel 2141.

The processor 2110 may obtain an external input via an input module 2130 or a sensor module 2161 and may execute an application corresponding to the external input. For example, when the user selects a camera icon displayed on the display panel 2141, the processor 2110 may obtain a user input via an input sensor 2161-2 and may activate a camera module 2171. The processor 2110 may transfer image data corresponding to an image captured by the camera module 2171 to the display module 2140. The display module 2140 may display an image corresponding to the captured image via the display panel 2141.

As another example, when personal information authentication is executed in the display module 2140, a fingerprint sensor 2161-1 may obtain input fingerprint information as input data. The processor 2110 may compare the input data obtained by the fingerprint sensor 2161-1 with authentication data stored in the memory 2120, and may execute an application according to the comparison result. The display module 2140 may display information executed according to application logic via the display panel 2141.

As another example, when a music streaming icon displayed on the display module 2140 is selected, the processor 2110 obtains a user input via the input sensor 2161-2 and may activate a music streaming application stored in the memory 2120. When a music execution command is input in the music streaming application, the processor 2110 may activate a sound output module 2163 to provide sound information corresponding to the music execution command to the user.

In the above, an operation of the electronic device 2101 has been briefly described. Hereinafter, a configuration of the electronic device 2101 will be described in detail. Some components of the electronic device 2101 described below may be integrated and provided as one component or one component may be provided separately as two or more components.

The electronic device 2101 may communicate with an external electronic device 2102 via a network (e.g., a short-range wireless communication network or a long-range wireless communication network). In an embodiment, the electronic device 2101 may include the processor 2110, the memory 2120, the input module 2130, the display module 2140, a power management module 2150, an internal module 2160 and an external module 2170. In an embodiment, at least one of the components may be omitted from the electronic device 2101 or one or more other components may be added in the electronic device 2101. In an embodiment, some of the components (e.g., the sensor module 2161, an antenna module 2162 or the sound output module 2163) may be implemented as a single component (e.g., the display module 2140).

The processor 2110 may execute software to control at least one other component (e.g., a hardware or software component) of the electronic device 2101 coupled with the processor 2110 and may perform various data processing or computation. According to an embodiment, as at least part of the data processing or computation, the processor 2110 may store a command or data received from another component (e.g., the input module 2130, the sensor module 2161 or a communication module 2173) in a volatile memory 2121, may process the command or the data stored in the volatile memory 2121 and may store resulting data in a non-volatile memory 2122.

The processor 2110 may include a main processor 2111 and an auxiliary processor 2112. The main processor 2111 may include one or more of a central processing unit (CPU) 2111-1 or an application processor (AP). The main processor 2111 may further include any one or more of a graphics processing unit (GPU) 2111-2, a communication processor (CP) and an image signal processor (ISP). The main processor 2111 may further include a neural processing unit (NPU) 2111-3. The NPU 2111-3 may be a processor specialized in processing an artificial intelligence model and the artificial intelligence model may be generated through machine learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof, but is not limited thereto. The artificial intelligence model may, additionally or alternatively, include a software structure other than a hardware structure. At least two of the above-described processing units and processors may be implemented as an integrated component (e.g., a single chip) or respective processing units and processors may be implemented as independent components (e.g., a plurality of chips).

The auxiliary processor 2112 may include a controller. The controller may include an interface conversion circuit and a timing control circuit. The controller may receive an image signal from the main processor 2111, may convert a data format of the image signal to meet interface specifications with the display module 2140 and may output image data. The controller may output various control signals required for driving the display module 2140.

The auxiliary processor 2112 may further include a data conversion circuit 2112-2, a gamma correction circuit 2112-3, a rendering circuit 2112-4 or the like. The data conversion circuit 2112-2 may receive image data from the controller. The data conversion circuit 2112-2 may compensate for the image data such that an image is displayed with a desired luminance according to characteristics of the electronic device 2101 or the user's setting or may convert the image data to reduce power consumption or to eliminate an afterimage. The gamma correction circuit 2112-3 may convert image data or a gamma reference voltage so that an image displayed on the electronic device 2101 has desired gamma characteristics. The rendering circuit 2112-4 may receive image data from the controller and may render the image data in consideration of a pixel arrangement of the display panel 2141 in the electronic device 2101. At least one of the data conversion circuit 2112-2, the gamma correction circuit 2112-3 and the rendering circuit 2112-4 may be integrated in another component (e.g., the main processor 2111 or the controller). At least one of the data conversion circuit 2112-2, the gamma correction circuit 2112-3 and the rendering circuit 2112-4 may be integrated in a data driver 2143 described below.

The memory 2120 may store various data used by at least one component (e.g., the processor 2110 or the sensor module 2161) of the electronic device 2101. The various data may include, for example, input data or output data for a command related thereto. The memory 2120 may include at least one of the volatile memory 2121 and the non-volatile memory 2122.

The input module 2130 may receive a command or data to be used by the components (e.g., the processor 2110, the sensor module 2161 or the sound output module 2163) of the electronic device 2101 from the outside of the electronic device 2101 (e.g., the user or the external electronic device 2102).

The input module 2130 may include a first input module 2131 for receiving a command or data from the user and a second input module 2132 for receiving a command or data from the external electronic device 2102. The first input module 2131 may include a microphone, a mouse, a keyboard, a key (e.g., a button) or a pen (e.g., a passive pen or an active pen). The second input module 2132 may support a designated protocol capable of connecting the electronic device 2101 to the external electronic device 2102 by wire or wirelessly. In an embodiment, the second input module 2132 may include a high definition multimedia interface (HDMI), a universal serial bus (USB) interface, an SD card interface or an audio interface. The second input module 2132 may include a connector that may physically connect the electronic device 2101 to the external electronic device 2102. For example, the second input module 2132 may include an HDMI connector, a USB connector, an SD card connector or an audio connector (e.g., a headphone connector).

The display module 2140 may visually provide information to the user. The display module 2140 may include the display panel 2141, a gate driver 2142 and the data driver 2143. The display module 2140 may further include a window, a chassis and a bracket for protecting the display panel 2141.

The display panel 2141 may include a liquid crystal display panel, an organic light emitting display panel or an inorganic light emitting display panel, but the type of the display panel 2141 is limited thereto. The display panel 2141 may be a rigid type display panel or a flexible type display panel capable of being rolled or folded. The display module 2140 may further include a supporter, a bracket or a heat dissipation member that supports the display panel 2141.

The gate driver 2142 may be mounted on the display panel 2141 as a driving chip. In an embodiment, the gate driver 2142 may be integrated into the display panel 2141. For example, the gate driver 2142 may include an amorphous silicon TFT gate driver circuit (ASG), a low temperature polycrystalline silicon (LTPS) TFT gate driver circuit or an oxide semiconductor TFT gate driver circuit (OSG) embedded in the display panel 2141. The gate driver 2142 may receive a control signal from the controller and may output scan signals to the display panel 2141 in response to the control signal.

The display panel 2141 may further include an emission driver. The emission driver may output an emission control signal to the display panel 2141 in response to a control signal received from the controller. The emission driver may be formed separately from the gate driver 2142 or may be integrated into the gate driver 2142.

The data driver 2143 may receive a control signal from the controller, may convert image data into analog voltages (e.g., data voltages) in response to the control signal and then may output the data voltages to the display panel 2141.

The data driver 2143 may be incorporated into other components (e.g., the controller). Further, the functions of the interface conversion circuit and the timing control circuit of the controller described above may be integrated into the data driver 2143.

The display module 2140 may further include the emission driver, a voltage generator circuit or the like. The voltage generator circuit may output various voltages used to drive the display panel 2141.

The power management module 2150 may supply power to the components of the electronic device 2101. The power management module 2150 may include a battery that charges a power supply voltage. The battery may include a primary cell which is not rechargeable, a secondary cell which is rechargeable or a fuel cell. The power management module 2150 may include a power management integrated circuit (PMIC). The PMIC may supply optimal power to each of the modules described above and modules described below. The power management module 2150 may include a wireless power transmission/reception member electrically connected to the battery. The wireless power transmission/reception member may include a plurality of antenna radiators in the form of coils.

The electronic device 2101 may further include the internal module 2160 and the external module 2170. The internal module 2160 may include the sensor module 2161, the antenna module 2162 and the sound output module 2163. The external module 2170 may include the camera module 2171, a light module 2172 and the communication module 2173.

The sensor module 2161 may detect an input by the user's body or an input by the pen of the first input module 2131 and may generate an electrical signal or data value corresponding to the input. The sensor module 2161 may include at least one of the fingerprint sensor 2161-1, the input sensor 2161-2 and a digitizer 2161-3.

The fingerprint sensor 2161-1 may generate a data value corresponding to the user's fingerprint. The fingerprint sensor 2161-1 may include any one of an optical type fingerprint sensor and a capacitive type fingerprint sensor.

The input sensor 2161-2 may generate a data value corresponding to coordinate information of the user's body input or the pen input. The input sensor 2161-2 may convert a capacitance change caused by the input into the data value. The input sensor 2161-2 may detect the input by the passive pen or may transmit/receive data to/from the active pen.

The input sensor 2161-2 may measure a bio-signal, such as blood pressure, moisture or body fat. For example, when a portion of the body of the user touches a sensor layer or a sensing panel and does not move for a certain period of time, the input sensor 2161-2 may output information desired by the user to the display module 2140 by detecting the bio-signal based on a change in electric field due to the portion of the body.

The digitizer 2161-3 may generate a data value corresponding to coordinate information of the input by the pen. The digitizer 2161-3 may convert an amount of an electromagnetic change caused by the input into the data value. The digitizer 2161-3 may detect the input by the passive pen or may transmit/receive data to/from the active pen.

At least one of the fingerprint sensor 2161-1, the input sensor 2161-2 and the digitizer 2161-3 may be implemented as a sensor layer formed on the display panel 2141 through a continuous process. The fingerprint sensor 2161-1, the input sensor 2161-2 and the digitizer 2161-3 may be disposed above the display panel 2141 or at least one of the fingerprint sensor 2161-1, the input sensor 2161-2 and the digitizer 2161-3 may be disposed below the display panel 2141.

Two or more of the fingerprint sensor 2161-1, the input sensor 2161-2 and the digitizer 2161-3 may be integrated into one sensing panel through the same process. When integrated into one sensing panel, the sensing panel may be disposed between the display panel 2141 and a window disposed above the display panel 2141. In an embodiment, the sensing panel may be disposed on the window, but the location of the sensing panel is not limited thereto.

At least one of the fingerprint sensor 2161-1, the input sensor 2161-2 and the digitizer 2161-3 may be embedded in the display panel 2141. In other words, at least one of the fingerprint sensor 2161-1, the input sensor 2161-2 and the digitizer 2161-2 may be simultaneously formed through a process of forming elements (e.g., light emitting elements, transistors, etc.) included in the display panel 2141.

In addition, the sensor module 2161 may generate an electrical signal or a data value corresponding to an internal state or an external state of the electronic device 2101. The sensor module 2161 may further include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor or an illuminance sensor.

The antenna module 2162 may include one or more antennas for transmitting or receiving a signal or power to or from the outside. In an embodiment, the communication module 2173 may transmit or receive a signal to or from the external electronic device 2102 through an antenna suitable for a communication method. An antenna pattern of the antenna module 2162 may be integrated into one component (e.g., the display panel 2141) of the display module 2140 or the input sensor 2161-2.

The sound output module 2163 may output sound signals to the outside of the electronic device 2101. The sound output module 2163 may include, for example, a speaker or a receiver. The speaker may be used for general purposes, such as playing multimedia or playing record. The receiver may be used for receiving incoming calls. In an embodiment, the receiver may be implemented as separate from or as part of the speaker. A sound output pattern of the sound output module 2163 may be integrated into the display module 2140.

The camera module 2171 may capture a still image and a moving image. In an embodiment, the camera module 2171 may include one or more lenses, an image sensor or an image signal processor. The camera module 2171 may further include an infrared camera capable of measuring the presence or absence of the user, the user's location and the user's line of sight.

The light module 2172 may provide light. The light module 2172 may include a light emitting diode or a xenon lamp. The light module 2172 may operate in conjunction with the camera module 2171 or may operate independently of the camera module 2171.

The communication module 2173 may support establishing a wired or wireless communication channel between the electronic device 2101 and the external electronic device 2102 and performing communication via the established communication channel. The communication module 2173 may include a wireless communication module (e.g., a cellular communication module, a short-range wireless communication module or a global navigation satellite system (GNSS) communication module) or a wired communication module (e.g., a local area network (LAN) communication module or a power line communication (PLC) module). The communication module 2173 may communicate with the external electronic device 2102 via a short-range communication network (e.g., Bluetooth™, wireless-fidelity (Wi-Fi) direct or infrared data association (IrDA)) or a long-range communication network (e.g., a cellular network, the Internet or a computer network (e.g., LAN or wide area network (WAN)). These various types of communication modules 2173 may be implemented as a single chip or may be implemented as multi-chips separate from each other.

The input module 2130, the sensor module 2161, the camera module 2171 and the like may be used to control an operation of the display module 2140 in conjunction with the processor 2110.

The processor 2110 may output a command or data to the display module 2140, the sound output module 2163, the camera module 2171 or the light module 2172 based on input data received from the input module 2130. For example, the processor 2110 may generate image data corresponding to input data applied through a mouse or an active pen and may output the image data to the display module 2140. In an embodiment, the processor 2110 may generate command data corresponding to the input data and may output the command data to the camera module 2171 or the light module 2172. When no input data is received from the input module 2130 for a certain period of time, the processor 2110 may switch an operation mode of the electronic device 2101 to a low power mode or a sleep mode, thereby reducing power consumption of the electronic device 2101.

The processor 2110 may output a command or data to the display module 2140, the sound output module 2163, the camera module 2171 or the light module 2172 based on sensing data received from the sensor module 2161. For example, the processor 2110 may compare authentication data applied by the fingerprint sensor 2161-1 with authentication data stored in the memory 2120 and then may execute an application according to the comparison result. The processor 2110 may execute a command or output corresponding image data to the display module 2140 based on the sensing data sensed by the input sensor 2161-2 or the digitizer 2161-3. In a case where the sensor module 2161 includes a temperature sensor, the processor 2110 may receive temperature data from the sensor module 2161 and may further perform luminance correction on the image data based on the temperature data.

The processor 2110 may receive measurement data about the presence or absence of the user, the location of the user and the user's line of sight from the camera module 2171. The processor 2110 may further perform luminance correction on the image data based on the measurement data. For example, after the processor 2110 determines the presence or absence of the user based on the input from the camera module 2171, the data conversion circuit 2112-2 or the gamma correction circuit 2112-3 may perform the luminance correction on the image data and the processor 2110 may provide the luminance-corrected image data to the display module 2140.

At least some of the above-described components may be coupled mutually and communicate signals (e.g., commands or data) therebetween via an inter-peripheral communication scheme (e.g., a bus, general purpose input and output (GPIO), serial peripheral interface (SPI), mobile industry processor interface (MIPI) or ultra-path interconnect (UPI)). The processor 2110 may communicate with the display module 2140 via an agreed interface.

Further, any one of the above-described communication methods may be used between the processor 2110 and the display module 2140, but the communication method between the processor 2110 and the display module 2140 is not limited to the above-described communication method.

The electronic device 2101 according to various embodiments described above may be various types of devices. For example, the electronic device 2101 may include at least one of a portable communication device (e.g., a smart phone), a computer device, a portable multimedia device, a portable medical device, a camera, a wearable device and a home appliance. However, the electronic device 2101 according to embodiments is not limited to the above-described devices.

The display device according to the embodiments may be applied to a display apparatus included in a computer, a notebook, a mobile phone, a smart phone, a smart pad, a PMP, a PDA, an MP3 player, or the like.

The foregoing is illustrative of the present inventive concept and is not to be construed as limiting thereof. Although a few embodiments of the present inventive concept have been described, those skilled in the art will readily appreciate that many modifications are possible in the embodiments without materially departing from the novel teachings and advantages of the present inventive concept. Accordingly, all such modifications are intended to be included within the scope of the present inventive concept as defined in the claims. In the claims, means-plus-function clauses are intended to cover the structures described herein as performing the recited function and not only structural equivalents but also equivalent structures. Therefore, it is to be understood that the foregoing is illustrative of the present inventive concept and is not to be construed as limited to the specific embodiments disclosed, and that modifications to the disclosed embodiments, as well as other embodiments, are intended to be included within the scope of the appended claims. The present inventive concept is defined by the following claims, with equivalents of the claims to be included therein.

What is claimed is:

1. A display device comprising:
a display panel including a pixel;
a data driver configured to apply a data voltage based on a data signal to the pixel;
a voltage generator configured to generate driving voltages based on a voltage generation control signal; and
a driving controller configured to generate the data signal and control the data driver and the voltage generator,
wherein the pixel emits light at a setting grayscale based on the driving voltages and the data voltage,
wherein at least one driving voltage of the driving voltages is changed based on a setting luminance, and
wherein the data signal is generated based on a change of the at least one driving voltage and a voltage difference between a data voltage of a reference grayscale and a data voltage of the setting grayscale.

2. The display device of claim 1, wherein the driving controller generates the data signal based on the voltage difference, the change of the at least one driving voltage and offset data corresponding to the change of the at least one driving voltage.

3. The display device of claim 2, wherein the offset data is generated based on an offset look-up table corresponding to the change of the at least one driving voltage.

4. The display device of claim 3, wherein the driving controller stores a plurality of offset look-up tables comprising the offset look-up table,
wherein the offset look-up tables include a first offset look-up table, a second offset look-up table and a third offset look-up table, and
wherein the second offset look-up table is generated through linear interpolation with the first offset look-up table and the third offset look-up table.

5. The display device of claim 2, wherein the data signal includes a first data signal for outputting a data voltage corresponding to a first grayscale and a second data signal for outputting a data voltage corresponding to a second grayscale higher than the first grayscale,
wherein the first data signal is generated based on the voltage difference, the change of the at least one driving voltage and the offset data, and
wherein the second data signal is generated based on the voltage difference and the offset data.

6. The display device of claim 2, wherein the data signal is generated based on a final offset voltage,
wherein the final offset voltage is calculated by using a first equation,
wherein the first equation is Vfoff=ΔDV*offset(Gray)*(Vdata_{REF}−Vdata_{Gray}), and
wherein the Vfoff is the final offset voltage, the ΔDV is the change of the at least one driving voltage, the offset(Gray) is a voltage corresponding to the offset data and the Vdata_{REF}−Vdata_{Gray} is the voltage difference.

7. The display device of claim 2, wherein the driving controller includes:
an input control signal receiver configured to output the voltage generation control signal and change data corresponding to a change of the at least one driving voltage;
an offset determiner configured to output the offset data based on the change data; and
a data signal compensator configured to receive the change data and the offset data, and generate the data signal considering a final offset voltage in a data voltage corresponding to input image data, and
wherein the data signal compensator calculates the final offset voltage based on the change data, the offset data and the voltage difference.

8. The display device of claim 1, wherein the pixel includes:
a driving transistor configured to output a driving current based on the data voltage and a high power voltage;
a write transistor configured to apply the data voltage to the driving transistor in response to a gate signal; and
a light emitting element including a first electrode receiving the driving current and a second electrode receiving a low power voltage,
wherein the driving voltages include the high power voltage and the low power voltage, and
wherein the at least one driving voltage is the low power voltage.

9. The display device of claim 8, wherein the driving controller generates the data signal based on the voltage difference, a change of the low power voltage and low power voltage offset data corresponding to the change of the low power voltage.

10. The display device of claim 1, wherein the pixel includes:
a driving transistor configured to output a driving current based on the data voltage and a high power voltage;
a writing transistor configured to apply the data voltage to the driving transistor in response to a gate signal;
an initialization transistor configured to apply an initialization voltage to a control electrode of the driving transistor; and
a light emitting element including a first electrode receiving the driving current and a second electrode receiving a low power voltage,
wherein the driving voltages include the high power voltage, the low power voltage and the initialization voltage,
wherein the at least one driving voltage is the initialization voltage, and
wherein the driving controller generates the data signal based on the voltage difference, a change of the initialization voltage and initialization voltage offset data corresponding to the change of the initialization voltage.

11. The display device of claim 1, further comprising a gate driver configured to generate a gate signal based on a gate high voltage and a gate low voltage,
wherein the pixel includes:
a driving transistor configured to output a driving current based on the data voltage and a high power voltage;
a writing transistor configured to apply the data voltage to the driving transistor in response to a gate signal;
an initialization transistor configured to apply an initialization voltage to a control electrode of the driving transistor; and
a light emitting element including a first electrode receiving the driving current and a second electrode receiving a low power voltage,
wherein the driving voltages include the gate high voltage, the gate low voltage, the high power voltage, the low power voltage and the initialization voltage,
wherein the at least one driving voltage is the gate low voltage, and
wherein the driving controller generates the data signal based on the voltage difference, a change of the gate low voltage and gate voltage offset data corresponding to the change of the gate low voltage.

12. The display device of claim 1, further comprising a gate driver configured to generate a gate signal based on a gate high voltage and a gate low voltage,
wherein the pixel includes:
a driving transistor configured to output a driving current based on the data voltage and a high power voltage;
a writing transistor configured to apply the data voltage to the driving transistor in response to a gate signal;
an initialization transistor configured to apply an initialization voltage to a control electrode of the driving transistor; and
a light emitting element including a first electrode receiving the driving current and a second electrode receiving a low power voltage,
wherein the driving voltages include the gate high voltage, the gate low voltage, the high power voltage, the low power voltage and the initialization voltage,
wherein the at least one driving voltage are the low power voltage, the initialization voltage and the gate low voltage, and
wherein the driving controller generates the data signal based on the voltage difference, a change of the low power voltage and integration offset data.

13. The display device of claim 12, wherein the integration offset data is generated based on an integration offset look-up table considering the change of the low power voltage, a change of the initialization voltage and a change of the gate low voltage.

14. The display device of claim 1, wherein the reference grayscale is a maximum grayscale in which the pixel emits light.

15. A display device comprising:
a display panel including a pixel;
a data driver configured to apply a data voltage based on a data signal to the pixel;
a voltage generator configured to generate driving voltages based on a voltage generation control signal; and
a driving controller configured to generate the data signal and control the data driver and the voltage generator,
wherein the pixel emits light at a setting grayscale based on the driving voltages and the data voltage,
wherein at least one driving voltage of the driving voltages is changed based on a setting luminance, and
wherein the data signal is generated based on a change of the at least one driving voltage and offset data corresponding to the change of the at least one driving voltage.

16. The display device of claim 15, wherein the offset data is generated based on an offset look-up table corresponding to the change of the at least one driving voltage.

17. The display device of claim 16, wherein the driving controller stores a plurality of offset look-up tables comprising the offset look-up table,
wherein the offset look-up tables include a first offset look-up table, a second offset look-up table and a third offset look-up table, and
wherein the second offset look-up table is generated through linear interpolation with the first offset look-up table and the third offset look-up table.

18. The display device of claim 15, wherein when the setting luminance is lower than a reference luminance, the data signal is generated based on the change of the at least one driving voltage and the offset data, and
wherein when the setting luminance is higher than the reference luminance, the data signal is generated based on a voltage difference between a data voltage of a reference grayscale and a data voltage of the setting grayscale, the change of the at least one driving voltage and the offset data.

19. The display device of claim 18, further comprising a gate driver configured to generate a gate signal based on a gate high voltage and a gate low voltage,
wherein the pixel includes:
a driving transistor configured to output a driving current based on the data voltage and a high power voltage;
a writing transistor configured to apply the data voltage to the driving transistor in response to a gate signal;
an initialization transistor configured to apply an initialization voltage to a control electrode of the driving transistor; and
a light emitting element including a first electrode receiving the driving current and a second electrode receiving a low power voltage,
wherein the driving voltages include the gate high voltage, the gate low voltage, the high power voltage, the low power voltage and the initialization voltage,
wherein the at least one driving voltage is the low power voltage, the initialization voltage and the gate low voltage, and
wherein when the setting luminance is lower than a reference luminance, the driving controller generates the data signal based on the voltage difference, a change of the low power voltage and integration offset data.

20. An electronic device comprising:
a display panel including a pixel;
a panel driver configured to drive the display panel;
a power manager configured to output driving voltages to the display panel and the panel driver based on a voltage generation control signal; and
a controller configured to output an input control signal to the panel driver and output the voltage generation control signal,
wherein the panel driver includes:
a data driver configured to apply a data voltage based on a data signal to the pixel; and
a driving controller configured to generate the data signal and control the data driver,
wherein the pixel emits light at a setting grayscale based on the driving voltages and the data voltage,
wherein at least one driving voltage of the driving voltages is changed based on a setting luminance, and
wherein the data signal is generated based on a change of the at least one driving voltage and a voltage difference between a data voltage of a reference grayscale and a data voltage of the setting grayscale.
